(19) United States
(12) Patent Application Publication
(10) Pub. No.: US 2011/0307381 A1
(43) Pub. Date: Dec. 15, 2011

(54) METHODS AND SYSTEMS FOR THIRD PARTY AUTHENTICATION AND FRAUD DETECTION FOR A PAYMENT TRANSACTION

(76) Inventors: Paul Kim, San Jose, CA (US); Bobby Choi, Sunnyvale, CA (US)

(21) Appl. No.: 12/813,493

(22) Filed: Jun. 10, 2010

(51) Int. Cl. G06Q 40/00

(52) U.S. Cl. 705/44

(57) ABSTRACT

Described herein are methods and systems for third party authentication and fraud detection for a payment transaction between a consumer and a merchant. A third party authentication may occur during a consumer's registration with the payment system or during a consumer's transaction with a merchant. In one embodiment, a payment system receives user information from an electronic device of the consumer. The payment system receives a selection of a third party authentication option from the consumer. The payment system sends a request for a login window to a third party site. The consumer logs into the third party site using the login window. The payment system receives and saves a consumer's universally unique identifier (UUID) from the third party site. The consumer registers with the payment system by authenticating with the third party site. In another embodiment, the consumer authenticates successful with the payment system during a payment transaction.

### CROSS-REFERENCED APPLICATION

The present application is related to the following commonly-owned, concurrently-filed application: application Ser. No. ______ (Attorney Docket No. 8936P001), filed Jun. 10, 2010, entitled “METHODS AND SYSTEMS FOR PAYMENT PROCESSING BASED ON A MOBILE PHONE NUMBER.”

### TECHNICAL FIELD

Embodiments of the present invention relate to methods and systems for third party authentication and fraud detection for a payment transaction.

### BACKGROUND

The improvement of wireless mobile technologies and the Internet has led to various mobile payment systems. Currently, a mobile payment value chain involves mobile carriers.

For one prior approach, a consumer shops for an item or content from a merchant's site. A payment processor processes the transaction on behalf of the merchant. The payment processor places the consumer purchase charge onto a mobile carrier's bill. The mobile carrier has a preexisting relationship with the consumer based on the mobile service provided by the mobile carrier to the consumer. The mobile carrier sends an invoice to the consumer for the consumer charge. The consumer typically remits payment within 30 days. The payment is primarily made with credit cards, debit cards, automated clearing house (ACH), or checks.

Mobile billing leverages a pre-existing account without forcing pre-registration on consumers. Mobile billing provides the convenience of paying with a mobile phone in a ubiquitous manner. Mobile billing can be secure and private with no need to expose a credit card. However, mobile carriers are slow to provide this mobile payment service and additionally charge high fees (e.g., transaction cost of 50% of the consumer purchase).

### BRIEF DESCRIPTION OF THE DRAWINGS

The present invention is illustrated by way of example, and not by way of limitation, in the figures of the accompanying drawings and in which:

FIG. 1 illustrates an exemplary flow of a payment transaction 100 based on a mobile phone number with the payment transaction having no mobile carrier dependency according to one embodiment;

FIG. 2 illustrates a detailed flow of a payment transaction 200 having no mobile carrier dependency according to one embodiment;

FIG. 3 illustrates a flow diagram of one embodiment for a method 300 of initiating a transaction with a payment system;

FIGS. 4A and 4B illustrate a flow diagram of one embodiment for a method 400 of authenticating a mobile phone number with a payment system;

FIG. 5 illustrates an exemplary input window in accordance with one embodiment;

FIG. 6 illustrates an exemplary input window in accordance with another embodiment.

FIG. 7 illustrates an exemplary transaction success window in accordance with one embodiment;

FIG. 8 illustrates an exemplary first time transaction input window in accordance with another embodiment;

FIG. 9 illustrates an exemplary transaction success window in accordance with another embodiment;

FIG. 10 illustrate a flow diagram of one embodiment for a method 1000 of authenticating a mobile phone number with a payment system;

FIGS. 11A and 11B illustrate flow diagrams of one embodiment for a method 1100 of authenticating and verifying a consumer with a payment system;

FIGS. 12A and 12B illustrate flow diagrams of one embodiment for a method 1200 of completing a payment transaction;

FIG. 13 illustrates an exemplary flow of a secure mobile payment transaction 1300 with encrypted messages and data according to one embodiment;

FIG. 14 illustrates an exemplary user interface for an encrypt request message creator on a merchant portal site in accordance with one embodiment;

FIG. 15A illustrates a flow diagram of one embodiment for a method 1500 of validating a consumer with a payment system;

FIG. 15B illustrates a flow diagram of another embodiment for a method 1550 of validating a consumer with a payment system having a parallel processing mechanism;

FIG. 16 illustrates a flow diagram of one embodiment for a method 1600 of authenticating a consumer with a payment system;

FIG. 17 illustrates one embodiment of a consumer's authentication during registration with the payment system;

FIG. 18 illustrates an exemplary login window 1800 of a third party in accordance with one embodiment;

FIG. 19 illustrates one embodiment of a consumer's authentication during a payment transaction with the payment system;

FIG. 20 illustrate a block diagram of a fraud detection system in accordance with certain embodiments;

FIG. 21 illustrates a method of operating a fraud detection system of a payment system in accordance with certain embodiments;

FIG. 22 illustrates a method of operating a fraud detection system in accordance with another embodiment;

FIG. 23 illustrates an overview of protocols for a payment transaction according to one embodiment;

FIG. 24 illustrates a system overview for a payment transaction with a payment system having no mobile carrier dependency in accordance with certain embodiments;

FIG. 25 illustrates a network topology for a payment transaction with a payment system in accordance with certain embodiments;

FIG. 26 illustrates a network topology for a payment transaction with a payment system in accordance with another embodiment;

FIG. 27 illustrates a payment system for a payment transaction in accordance with one embodiment;

FIG. 28 illustrates a network topology for a payment transaction with a payment system in accordance with another embodiment; and

FIG. 29 illustrates a network topology for a payment transaction with a cloud service model and payment system in accordance with another embodiment.

### DETAILED DESCRIPTION

Described herein are methods and systems for third party authentication and fraud detection for a payment transaction between a consumer and a merchant. A third party authentication may occur during a consumer's registration with the payment system or during a consumer's transaction with a merchant. In one embodiment, a payment system receives user information from an electronic device of the consumer. Next, the payment system receives a selection of a third party authentication option (e.g., Facebook authentication option, Twitter authentication option, OpenID authentication option, etc.) from the consumer. The payment system generates and sends a request for a login window to a third party site. The consumer logs into the third party site using the login window. The payment system receives and saves a consumer's universally unique identifier (UUID) from the third party site. In one embodiment, the consumer registers with the payment system by authenticating with the third party site. In another embodiment, if the processing logic matches the received UUID with a previously stored UUID, then the consumer authenticates successful with the payment system during a payment transaction.

The payment system completes the payment transaction by granting micro-credit to the consumer with no pre-registration and no mobile carrier dependency.

After receiving the good or service from the online merchant, the consumer then post-registers at the payment system's site within a certain time period (e.g., 7 days, 14 days) and pays for the transaction using one of many payment options provided at the site (e.g., credit card, automated clearing house, cash or money orders received via mail, retail store or kiosk payments such as at Coinstar®, etc.).

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

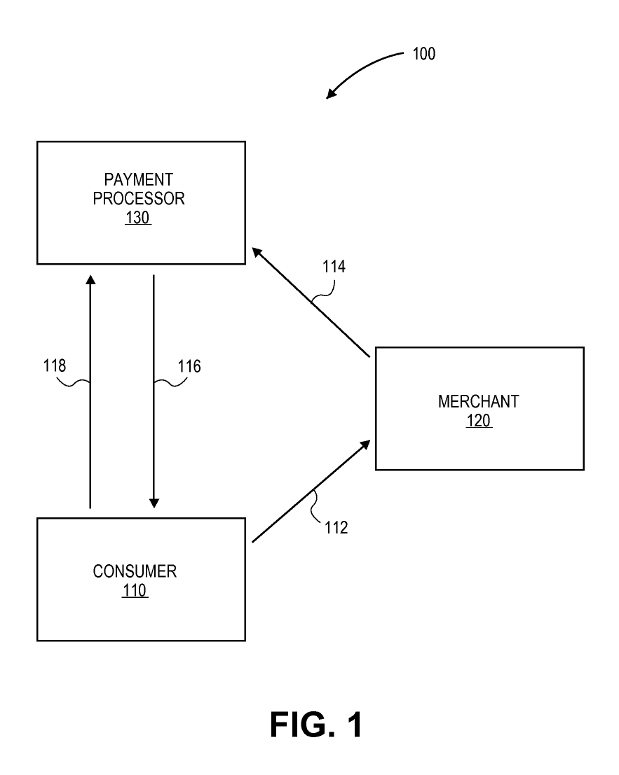

FIG. 1 illustrates an exemplary flow of a payment transaction 100 based on a mobile phone number with the transaction having no mobile carrier dependency according to one embodiment. At operation 112, a consumer 110 shops for a product (e.g., item, content) or service from a merchant's site 120. At operation 114, a payment processor 130 processes the transaction based on a mobile number received from the consumer. The payment processor 130 processes the transaction on behalf of the merchant. At operation 116, the payment processor 130 grants micro-credit to the consumer 110 without any pre-registration. The consumer receives the product or service from the merchant's site based on the micro-credit even though the consumer has not paid for the product or service. The elimination of pre-registration reduces friction and promotes high consumer adoption rates with the merchant. Thus, the merchant increases consumer sales.

The payment processor 130 may subsequently send a communication (e.g., SMS, email, etc.) to the consumer to have the consumer complete the transaction with post-registration and payment. At block 118, the consumer performs post-registration and remits payment to the payment processor within a certain time period (e.g., 14 days). The payment processor 130 can provide numerous payment options including credit card, debit card, ACH, mailing in cash or money orders, paying at retail stores and kiosks (e.g., Coinstar®), a “billing one's parents” option, and other options as well. The mobile payment transaction 100 provides immediate access to all mobile subscribers without charging a mobile bill and with no dependency on mobile carriers.

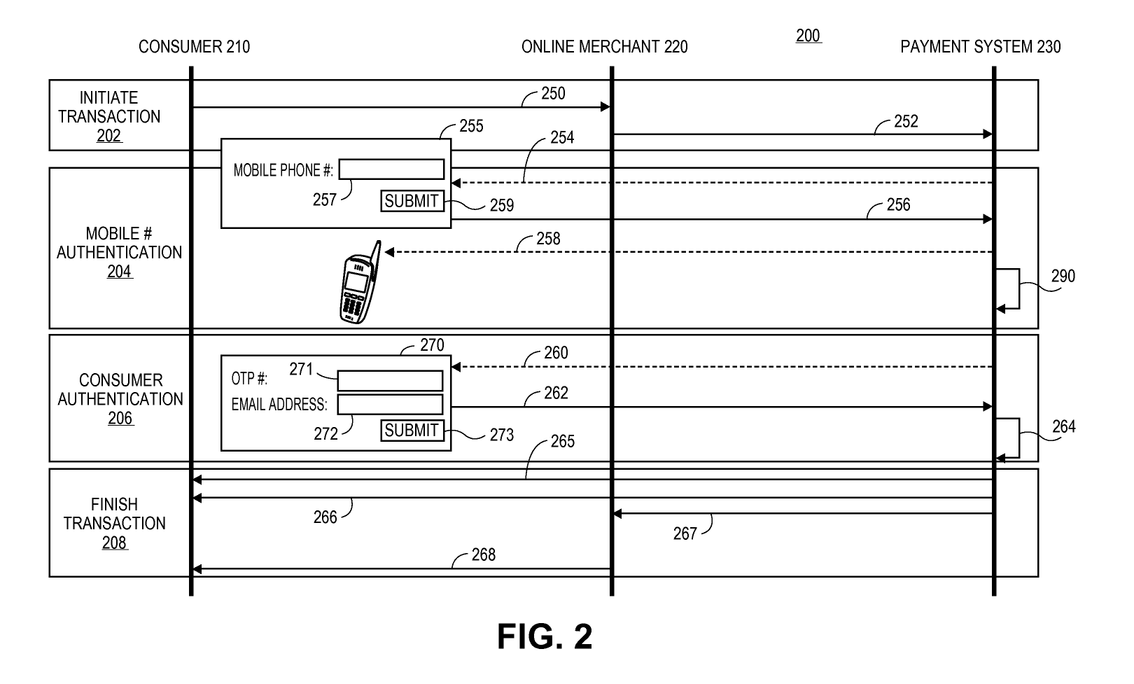

FIG. 2 illustrates a detailed flow of a payment transaction 200 according to one embodiment. The mobile payment transaction 200 includes the following components: initiate transaction 202 (e.g., operations 250 and 252), mobile number authentication 204 (e.g., operations 254, 256, 258, and 290), consumer authentication 206 (e.g., operations 260, 262, and 264), and finish transaction 208 (e.g., operations 265, 266, 267, and 268). At operation 250, a consumer 100 with an electronic device (e.g., mobile device, computing device, computer, laptop, tablet, netbook, hand-held device, etc.) shops for a product (e.g., item, content) or service from an online merchant's site and selects a payment option to purchase the product or service. At operation 252, the online merchant 220 sends a payment transaction request to a payment system 230 (e.g., payment processor 130). At operation 254, the payment system 230 generates a mobile phone input window 255 having an input region 257 that is displayed on the electronic device of the consumer. For example, the input window may be displayed within a web browser of the electronic device. At operation 256, the consumer inputs to the region 257 a mobile phone number associated with a mobile device of the consumer and submits the mobile phone number to the payment system 230 by selecting the submit option 259. In one embodiment, the consumer accesses the online merchant with an electronic device other than a mobile device (e.g., personal computer) and provides the mobile phone number of a mobile device used by the consumer. In another embodiment, the consumer accesses the online merchant with a mobile device and provides the mobile phone number of this mobile device.

At operation 258, the payment system 230 generates a one time passcode (OTP) that is sent to the mobile device. In an embodiment, the OTP is sent via SMS.

At operation 290, the payment system 230 checks an internal database to determine whether the consumer is a registered user and whether this is the consumer's first transaction with the payment system.

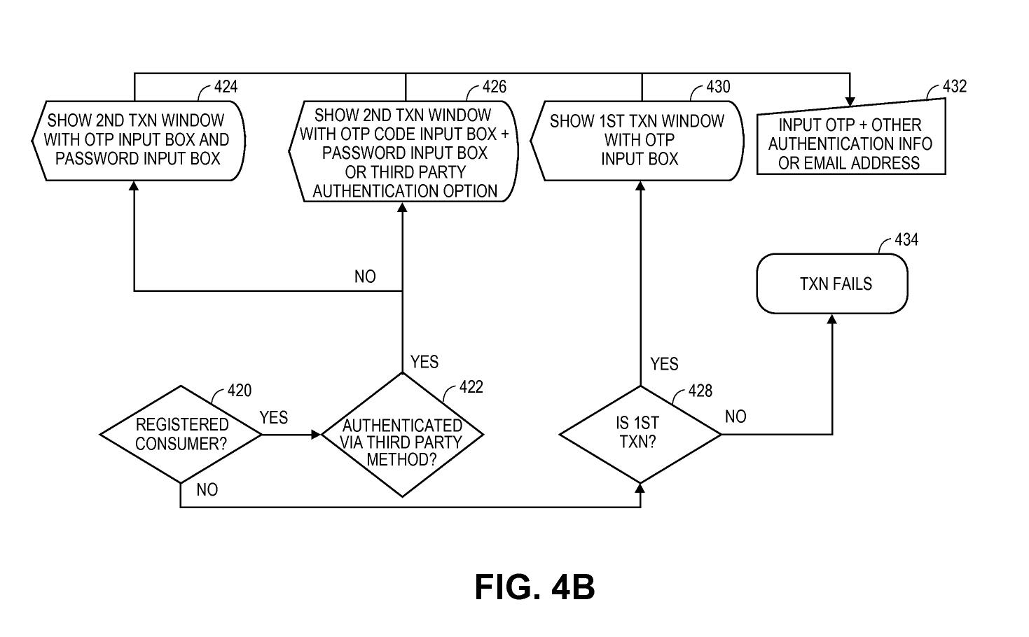

At operation 260, the payment system 230 refreshes the previous window with a OTP input window 270 according to some embodiments. The window 270 that is displayed on the electronic device depends on whether this is the consumer's first transaction with the payment system 230 and whether the consumer has registered previously with payment system 230. FIGS. 5, 6, and 8 illustrate exemplary windows that may be generated as window 270. The input window 270 includes an input region 271 for entering the OTP and an input region 272 for entering user contact information (e.g., an email address) for a first time transaction. If this is a second or subsequent transaction for the consumer with the payment system 230, then the email address input region is replaced with authentication information such as a personal PIN or a third party password (e.g., Facebook password, Twitter password, OpenID password, etc.) input region. At operation 262, the consumer submits the OTP and email address to the payment system 230 by selecting the submit option 273 for a first time transaction. Alternatively, the consumer submits the OTP and authentication information for a second or subsequent transaction. At operation 264, the payment system 230 authenticates the consumer with the two factor information provided by the consumer.

At operation 265, the payment system 230 notifies the consumer whether the transaction was successfully completed or failed. At operation 266, the payment system extends micro-credit to the consumer with no pre-registration if this is the consumer's first transaction with the payment system. The micro-credit may be limited to a certain amount (e.g., twenty dollars) for a first time consumer. At operation 267, the payment system 230 notifies the merchant whether the transaction was successfully completed or failed. Then, at operation 268, the merchant provides the product or service to the consumer for a successful transaction.

In an embodiment, the consumer notification may include a post-registration and payment option. The consumer receives the product or service from the merchant's site based on the micro-credit even though the consumer has not paid for the product or service. The consumer can perform post-registration and remit payment to the payment processor within a certain time period (e.g., 14 days).

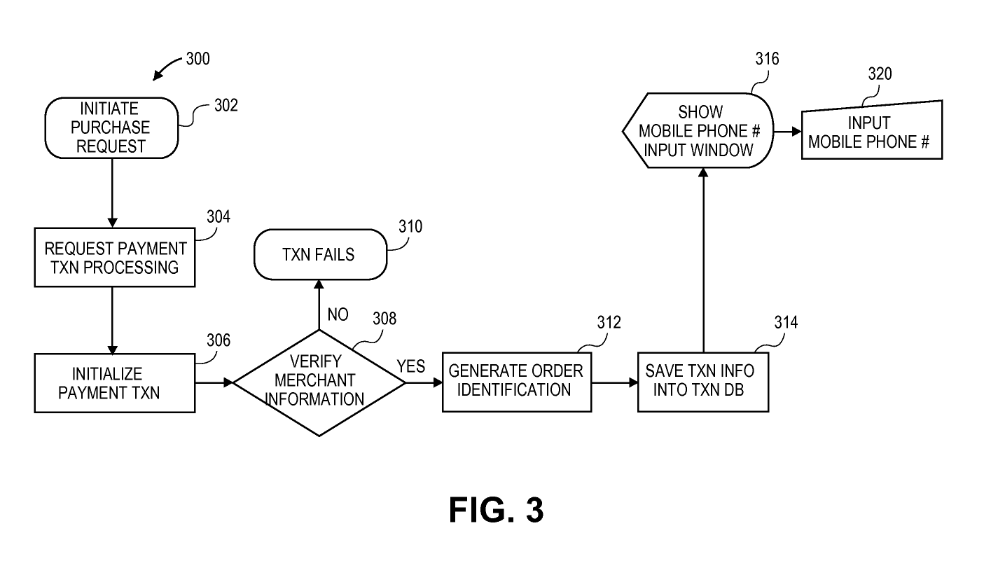

FIG. 3 illustrates a flow diagram of one embodiment for a method 300 of initiating a transaction with a payment system. The method 300 is performed by processing logic that may comprise hardware (circuitry, dedicated logic, etc.), software (such as is run on a general purpose computer system or a dedicated machine or a device), or a combination of both. In one embodiment, the method 300 is performed by processing logic of the payment processor or payment system discussed herein.

In an embodiment, the payment processor and/or payment system may be a machine within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a computer, a data processing system, a web appliance, a server, a network router, switch or bridge, data center, or any machine capable of executing a set of instructions (sequential or otherwise) that specify actions to be taken by that machine. Further, while only a single machine is illustrated, the term “machine” shall also be taken to include any collection of machines (e.g., servers, computers) that individually or jointly execute a set (or multiple sets) of instructions to perform any one or more of the methodologies discussed herein.

At block 302, a consumer initiates a purchase request from a merchant's site using an electronic device. At block 304, the processing logic of a payment system receives a transaction request message from the merchant. The transaction request message may include a merchant identifier, a merchant name, a service identifier, a service name, a sku identifier, a sku name, and a price. In one embodiment, the transaction request message is received via a communication protocol (e.g., http) and the message is encrypted by an advanced encryption standard (AES) algorithm. At block 306, the processing logic initializes a payment transaction by loading merchant information from a merchant management database (e.g., table). At block 308, the processing logic determines whether the received merchant information can be verified with registered merchant information of the payment system. In an embodiment, the merchant verification includes determining whether the merchant_id exists in the merchant management table, determining whether the merchant is available to service, and if the merchant_id and service_id match. If all three of the above conditions for determining verification successfully occur (e.g., merchant_id exists in the merchant management database, merchant is available to service, merchant_id matches service_id), then the merchant verification occurs successfully. A merchant may not be available if it has an expired or blocked status. A blocked status indicates that the merchant is disqualified. In an embodiment, a merchant provides more than one service (e.g., one merchant has multiple game services). The merchant may want each service managed separately.

The transaction fails if any of the conditions fail (e.g., merchant_id does not match service_id). In this case, the received merchant information can not be verified with the registered merchant information. The payment system sends a notification of the failure to the merchant at block 310. Alternatively, if the transaction can be verified successfully, then the processing logic generates an order identification at block 312. The processing logic then saves the transaction information into a transaction database at block 314. Next, the processing logic causes an input window for entering a mobile phone number to be displayed on the electronic device at block 316. The consumer enters the mobile phone number at block 320.

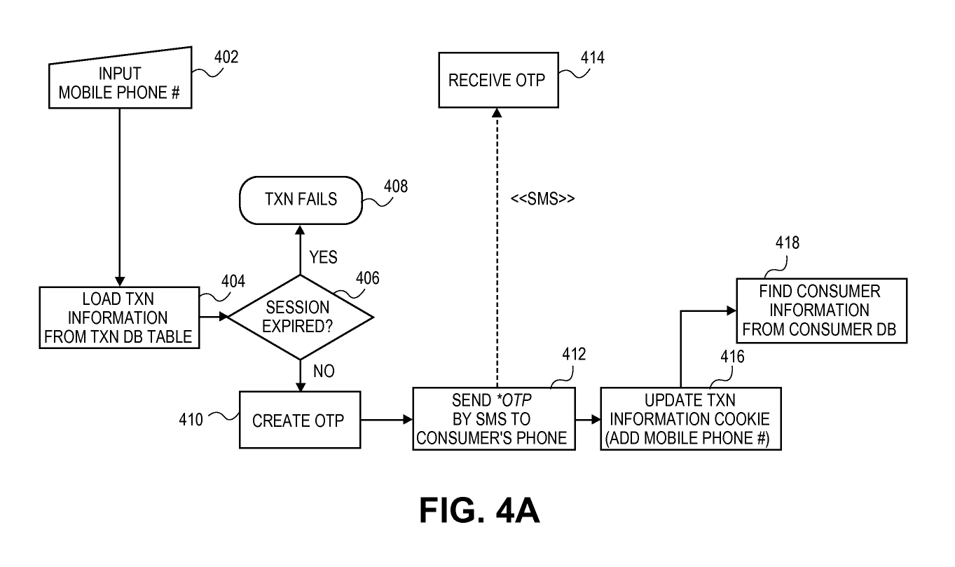

FIGS. 4A and 4B illustrate a flow diagram of one embodiment for a method 400 of authenticating a mobile phone number with a payment system. The method 400 is performed by processing logic that may comprise hardware (circuitry, dedicated logic, etc.), software (such as is run on a general purpose computer system or a dedicated machine or a device), or a combination of both. In one embodiment, the method 400 is performed by processing logic of the payment processor or payment system discussed herein.

At block 402, a consumer inputs a mobile phone number to an input window displayed on an electronic device of the consumer. The payment system receives an authentication request message that includes an order identification and the mobile phone number entered by the consumer. At block 404, the processing logic of the payment system loads transaction information from a transaction database of the payment system. At block 406, the processing logic determines whether a session has expired for receiving the mobile phone number from the consumer. In one embodiment, the session expires based on a certain time period (e.g., 5 minutes from initiation of the transaction). At block 408, the transaction fails based on expiration of the session with the merchant receiving a notification of the failure. At block 410, the processing logic generates a one time password (OTP) if the session has not expired at block 406. At block 412, the processing logic sends the OTP to a consumer's mobile device. The OTP may be sent via SMS.

At block 414, the consumer's mobile device receives the OTP. At block 416, the processing logic updates transaction information by adding the mobile phone number of the consumer to the transaction database. The updating may include updating a transaction information cookie. At block 418, the processing logic obtains consumer information by searching a consumer database.

Referring to FIG. 4B, at block 420, processing logic of the payment system determines whether the consumer is registered with the consumer database. At block 422, processing logic of the payment system determines whether the consumer is authenticated via a third party method (e.g., Facebook method, Twitter method, Open ID method, etc.) if the consumer is registered with the consumer database. If the consumer is not authenticated via a third party method, then the processing logic of the payment system generates an input window (for a second or subsequent transaction) with a OTP input region and a password input region associated with the payment system that is displayed on the electronic device of the consumer at block 424. If the consumer is authenticated via a third party method, then the processing logic of the payment system generates an input window (for a second or subsequent transaction) with a OTP input region that is displayed on the electronic device at block 426. The user input window also includes a password input region associated with the payment system or an input region with a third party authentication option (e.g., Facebook authentication option, Twitter authentication option, Open ID authentication option, etc.).

Returning to block 420, if the consumer is not registered with the consumer database, then the processing logic determines whether this is the first transaction for the consumer with the payment system at block 428. At block 430, the processing logic generates an input window with a OTP input region if the processing logic determines that the consumer is transacting for the first time with the payment system. The processing logic of the payment system determines that the transaction fails at block 434 if the processing logic determines that the consumer is not transacting for the first time with the payment system. The merchant receives notification of the failed transaction.

At block 432, the consumer inputs into the consumer's electronic device the OTP and other authentication information (e.g., password). Alternatively, the consumer inputs the OTP and contact information (e.g., email address) into the electronic device.

The payment system supports three types of authentication methods. For a first time transaction, the payment system uses OTP authentication. The payment system requests a consumer's email address in addition to the OTP authentication. For a registered consumer, the payment system requests a login password for the payment system and the OTP. For a registered consumer that authenticates with a third party (e.g., social media merchant, OpenID, etc.), the payment system requests a login password for the payment system or a third party's authentication password and the OTP. FIGS. 5-9 illustrate exemplary windows for these authentication methods. FIGS. 5, 6, and 8 illustrate windows that are generated in response to a consumer entering a mobile phone number into a mobile phone input window. In one embodiment, the windows are generated with rich client applications (e.g. Ajax, Flash, Java Script). A merchant can create its own customized payment page based on using APIs of the payment system.

FIG. 5 illustrates an exemplary input window in accordance with one embodiment. The input window 500 includes a OTP input region 510 and a password input region 520 associated with the payment system that is displayed on the electronic device of the consumer at block 424. The window 500 also includes a forgot your password link 530, a re-send (OTP) SMS link 540, a submit option 550 to submit the information entered into the regions 510 and 520. In an embodiment, a consumer can retry sending the OTP via SMS twice for a total of three attempts. If unsuccessful after three attempts, the consumer may contact consumer support.

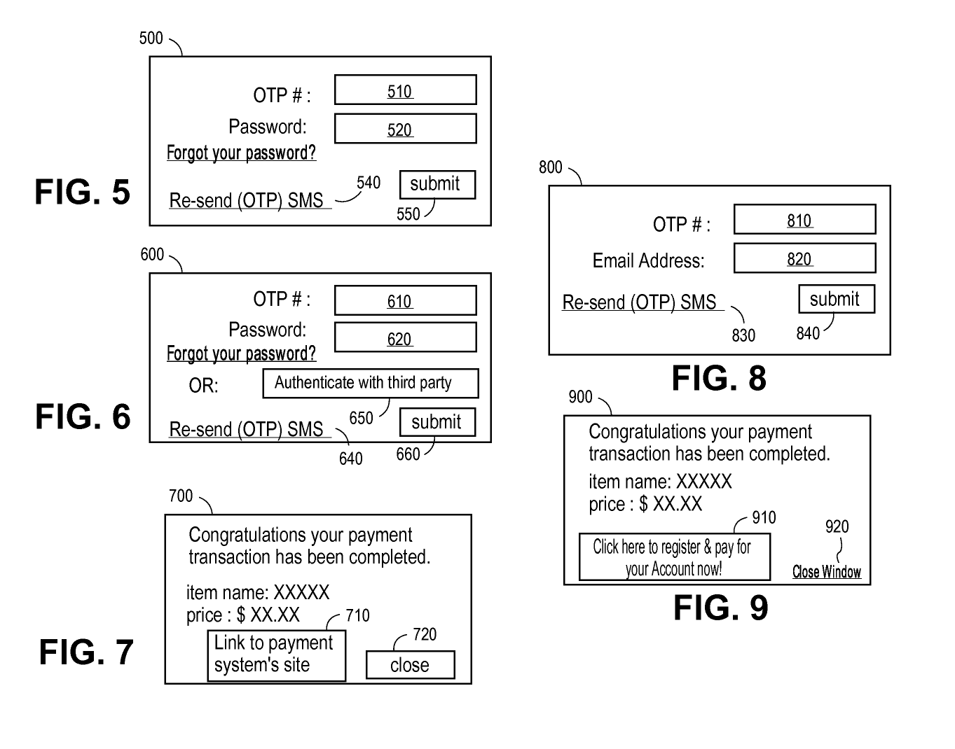

FIG. 6 illustrates an exemplary input window in accordance with another embodiment. The input window 600 includes a OTP input region that is displayed on the electronic device at block 426. The input window 600 includes a OTP input region 610 and a password input region 620 associated with the payment system that is displayed on the electronic device of the consumer at block 624. The window 600 also includes a forgot your password link 730, a re-send (OTP) SMS link 640, a submit option 650 to submit the information entering into the regions 610 and 620 to the payment system. In an embodiment, the window also includes an authenticate with third party option 650 (e.g., authenticate with Facebook, Twitter, OpenID, etc.) to authenticate with a third party. The option 650 is only available for consumers who have authenticated using a third party during their signup or account management process with the payment system.

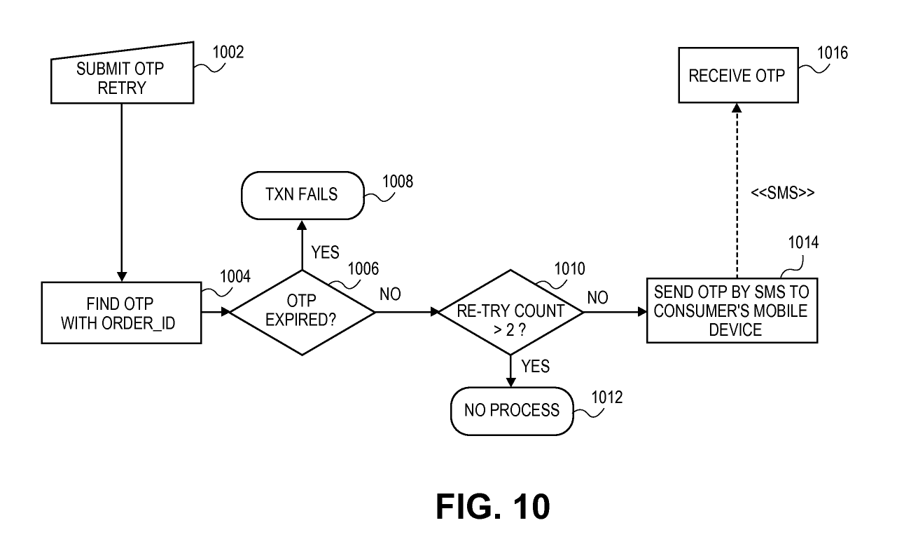

FIG. 7 illustrates an exemplary transaction success window in accordance with one embodiment. The window 700 is generated in response to selection of the submit options 550 or 660 of FIGS. 5 and 6 or authentication with a third party (e.g., Facebook, Twitter, OpenID, etc.). In an embodiment, the window 700 includes an indication that the consumer's payment transaction has been completed, an item name, and a price. The window 700 may include a link to consumer's account at payment system 710 and a close window option 720.

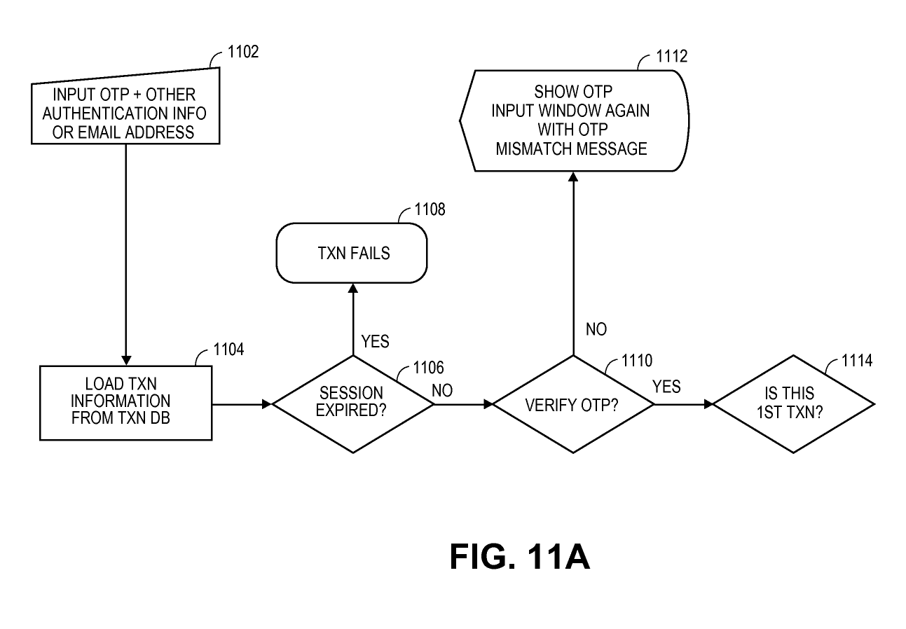

FIG. 8 illustrates an exemplary first time transaction input window in accordance with another embodiment. The input window 800 includes a OTP input region 810 and a contact information (e.g, email address) input region 820 associated with the consumer that is displayed on the electronic device of the consumer at block 430. The window 800 also includes a re-send (OTP) SMS link 830 and a submit option 840 to submit the information entering into the regions 810 and 820 to the payment system.

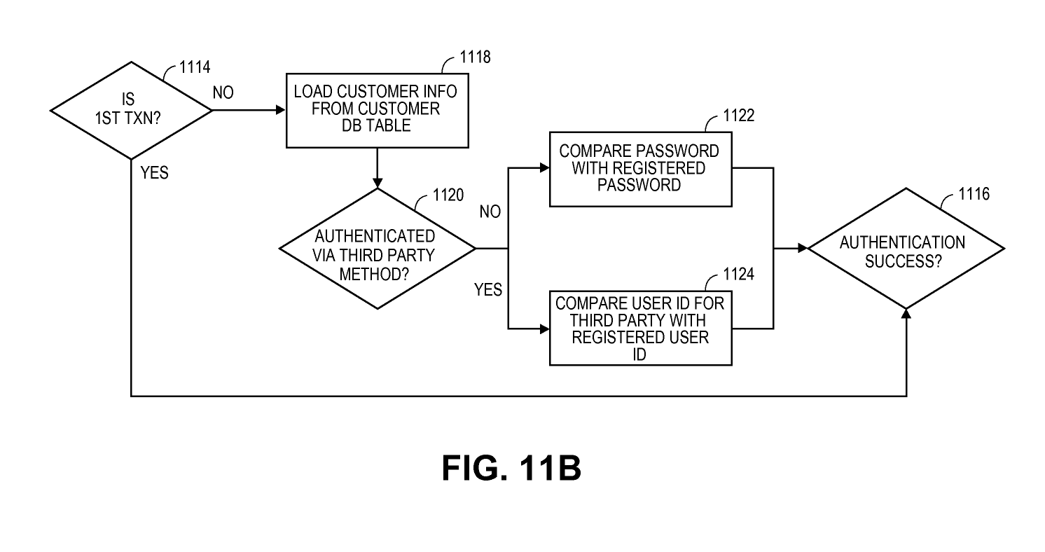

FIG. 9 illustrates an exemplary transaction success window in accordance with another embodiment. The window 900 is generated in response to selection of the submit option 840 of FIG. 8 for an initial transaction between the consumer and the payment system. In an embodiment, the window 900 includes an indication that the consumer's payment transaction has been completed, an item name, and a price. The window 900 includes a registration and payment option 910. For example, the consumer can select the option 910 to register with the payment system and provide payment information for purchasing the product or service.

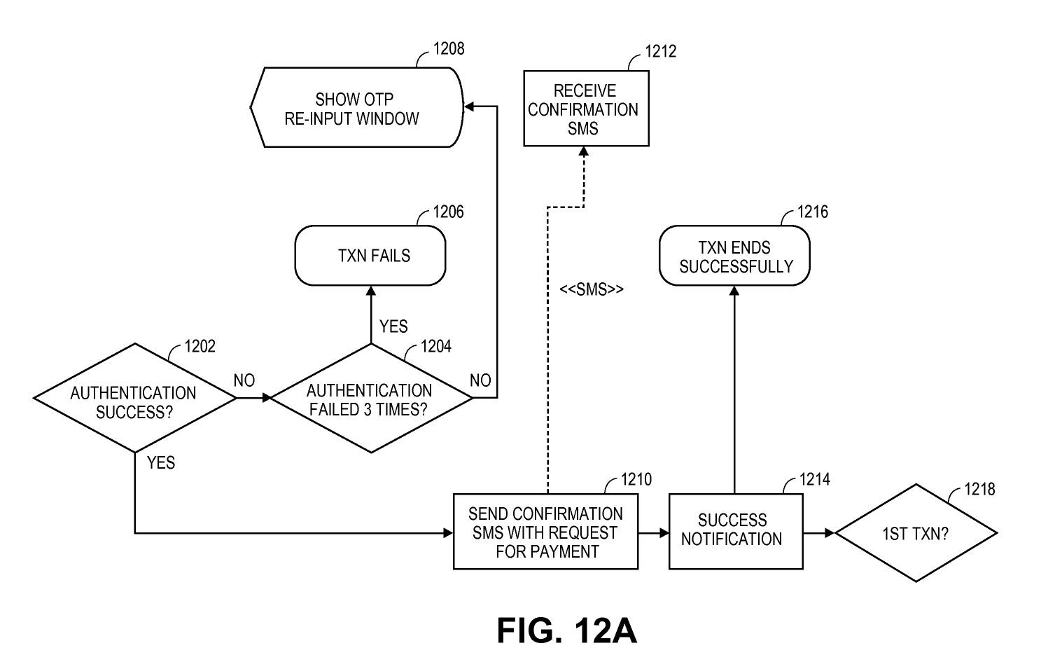

FIG. 10 illustrate a flow diagram of one embodiment for a method 1000 of authenticating a mobile phone number with a payment system. The method 1000 is performed by processing logic that may comprise hardware (circuitry, dedicated logic, etc.), software (such as is run on a general purpose computer system or a dedicated machine or a device), or a combination of both. In one embodiment, the method 1000 is performed by processing logic of the payment processor or payment system discussed herein.

At block 1002, a consumer retries receiving or inputting a OTP to an input window displayed on a electronic device of the consumer. The payment system receives the OTP retry. At block 1004, the processing logic of the payment system using the received order_id associated with the OTP retry finds the OTP from a database of the payment system. At block 1006, the processing logic determines whether the OTP has expired. In one embodiment, the OTP expires based on a certain time period (e.g., 5 minutes from initiation of the transaction) at block 1008. The merchant receives notification of the expiration. Otherwise, at block 1010, the processing logic determines whether the retry count is greater than a certain number (e.g., 2). If so, then the retry process is terminated at block 1012. If the retry count is not greater than the certain number, then the processing logic sends the OTP by SMS to the consumer's mobile device at block 1014. The consumer's mobile device receives the OTP at block 1016.

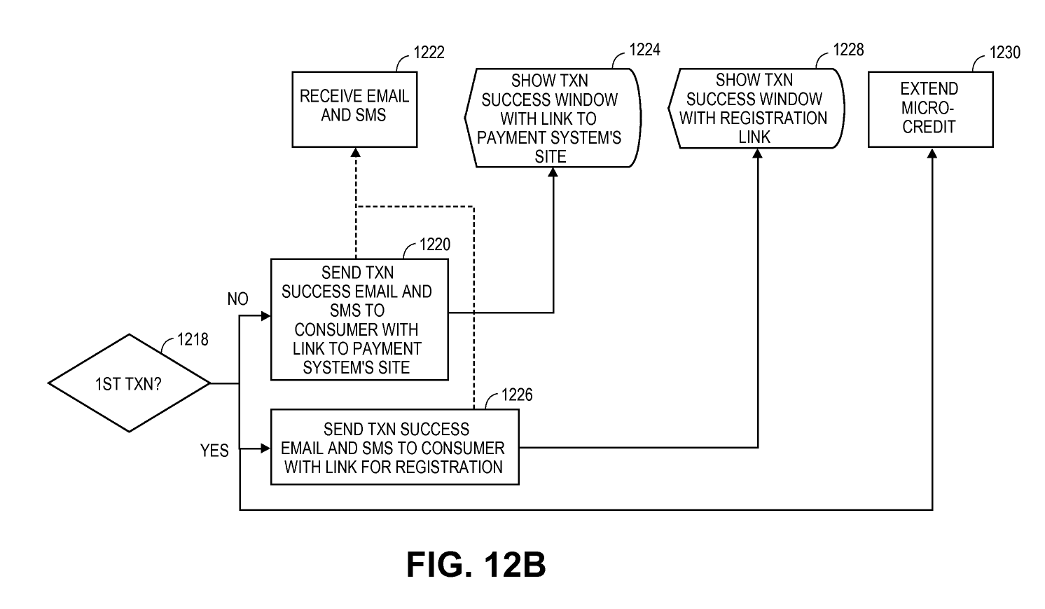

FIGS. 11A and 11B illustrate flow diagrams of one embodiment for a method 1100 of authenticating and verifying a consumer with a payment system. The method 1100 is performed by processing logic that may comprise hardware (circuitry, dedicated logic, etc.), software (such as is run on a general purpose computer system or a dedicated machine or a device), or a combination of both. In one embodiment, the method 1100 is performed by processing logic of the payment processor or payment system discussed herein.

At block 1102, a consumer inputs authentication information (e.g., OTP, password, email address, etc.) to an input window (e.g., 500, 600, 800) displayed on an electronic device of the consumer. The payment system receives the authentication information entered by the consumer. At block 1104, the processing logic of the payment system loads transaction information from a transaction database of the payment system. At block 1106, the processing logic determines whether a session has expired for receiving the authentication information from the consumer. In one embodiment, the session expires based on a certain time period (e.g., 5 minutes from initiation of the transaction). At block 1108, the transaction fails based on expiration of the session. The merchant receives notification of the expired failed transaction. At block 1110, if the session has not expired, then the processing logic verifies the one time password (OTP) received from the consumer. At block 1112, if the received OTP does not match the OTP obtained from the transaction database, then the processing logic causes the display of the OTP input window again to the consumer's electronic device along with a OTP mismatch message. In an embodiment, the consumer can retry sending the OTP twice for a total of three attempts. At block 1114, if the received OTP does match the OTP obtained from the transaction database, then the processing logic determines whether this is the consumer's first transaction with the payment system.

Referring to FIG. 11B, at block 1116, processing logic of the payment system determines whether authentication occurs successfully if the consumer is transacting with the payment system for the first time at block 1114. For a second or subsequent transaction, at block 1118, processing logic of the payment system loads consumer information from the consumer database table. At block 1120, processing logic determines whether the consumer is authenticated via a third party method. If the consumer is not authenticated via a third party method, then the processing logic of the payment system compares a password received from the consumer with a registered password at block 1122. The registered password is obtained from the consumer database table at block 1118 and the password received from the consumer is obtained at block 1102. If the consumer is authenticated via a third party method, then the processing logic of the payment system compares a user ID of the consumer for a third party with a registered user ID of the consumer for the payment system at block 1124. As discussed above, at block 1116, processing logic of the payment system determines whether authentication occurs successfully.

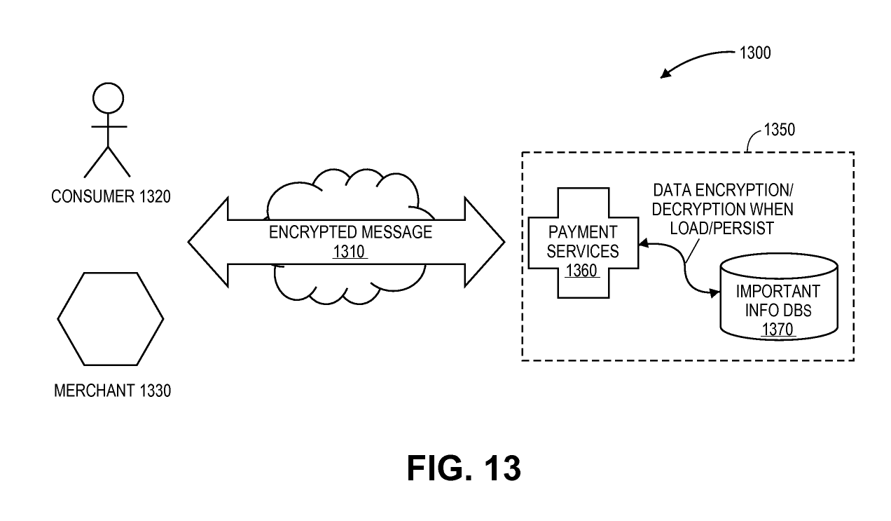

FIGS. 12A and 12B illustrate flow diagrams of one embodiment for a method 1200 of completing a payment transaction. The method 1200 is performed by processing logic that may comprise hardware (circuitry, dedicated logic, etc.), software (such as is run on a general purpose computer system or a dedicated machine or a device), or a combination of both. In one embodiment, the method 1200 is performed by processing logic of the payment processor or payment system discussed herein.

At block 1202, which is the same as block 1116, the processing logic of the payment system determines whether authentication occurs successfully. If the authentication is not successful, then the processing logic determines whether the authentication has failed a certain number of times (e.g., three) at block 1204. If so, then the processing logic notifies the merchant that the transaction fails at block 1206. Otherwise, the processing logic causes the electronic device to display the input window for entering the OTP at block 1208.

If the authentication is successful, then the processing logic sends a confirmation message (e.g., SMS) with a request for payment to the consumer's electronic device and/or mobile device at block 1210. The consumer receives the confirmation message at block 1212. The processing logic generates a transaction success notification at block 1214 that is sent to the merchant at block 1216. The processing logic determines whether the transaction is an initial transaction for the consumer with the payment system at block 1218.

Referring to FIG. 12B, the processing logic sends a transaction success message via email and SMS to the consumer with a link to payment system's site at block 1220 for a subsequent transaction between the consumer and the payment system. At block 1222, the consumer receives the transaction success message via email and SMS. The processing logic causes the electronic device to display the transaction success input window with a payment link to consumer's account at payment system at block 1224.

The processing logic sends a transaction success message via email and SMS to the consumer with a link for registration with the payment system at block 1226 for an initial transaction between the consumer and the payment system. The processing logic causes the electronic device to display the transaction success input window with a registration link at block 1228. The payment system extends micro-credit to the consumer with no pre-registration if this is the consumer's first transaction with the payment system at block 1230. The micro-credit may be limited to a certain amount (e.g., twenty dollars) for a first time consumer.

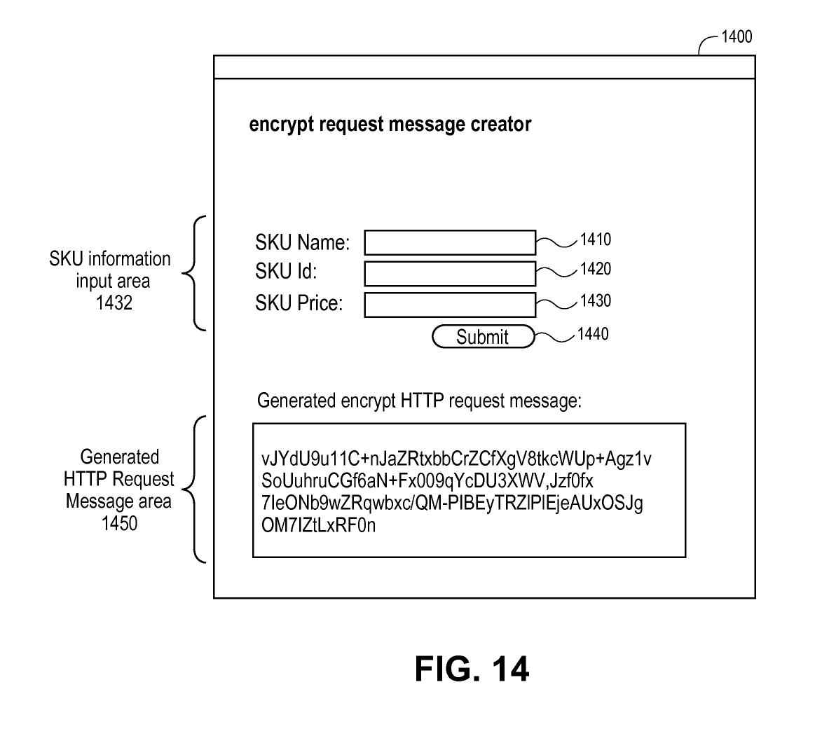

FIG. 13 illustrates an exemplary flow of a secure payment transaction 1300 with encrypted messages and data according to one embodiment. The encrypted message 1310 represents the encryption of all communications (e.g., requests, messages, etc.) between a consumer 1320, merchant 1330, and payment system 1350. The requests and messages have been previously illustrated in FIGS. 1 and 2. The payment system 1350 with payment services 1360 manages all important data (e.g., messages, requests, merchant/consumer payment method information, etc.) in a secure manner with encryption and decryption. The payment system 1350 encrypts and decrypts all data or certain important data (e.g., credit card information, bank account information, etc.) during load/persist operations for data stored in important information databases 1370. The information encrypted in databases 1370 is shielded from attack from external sources and also internal sources with respect to the payment system 1350.

Communication between the payment system 1350 and the consumer 1320 uses hypertext transfer protocol (HTTP) over secure socket layer (SSL), which is referred to as HTTP Secure (HTTPS). HTTP is insecure and is subject to man-in-the-middle and eavesdropping attacks, which can let attackers gain access to website accounts and sensitive information. HTTPS is designed to withstand such attacks and is considered secure (with the exception of older deprecated versions of SSL).

In one embodiment, communication between merchant and payment system uses simple object access protocol (SOAP). SOAP is XML communication over HTTPS.

Referring to FIG. 2, at operation 252, the online merchant 220 sends a payment transaction request to a payment system 230 (e.g., payment processor 130). The payment transaction request uses HTTP redirection. Thus, a consumer's web browser can read the http request parameter. This means the consumer can edit the http request parameter and forward the tampered message. Thus, the more secure the message (e.g., detect reading, modifying), the better. Therefore, this payment transaction request must be encrypted. The payment systems discussed herein support the encrypt request message creator on a merchant portal site.

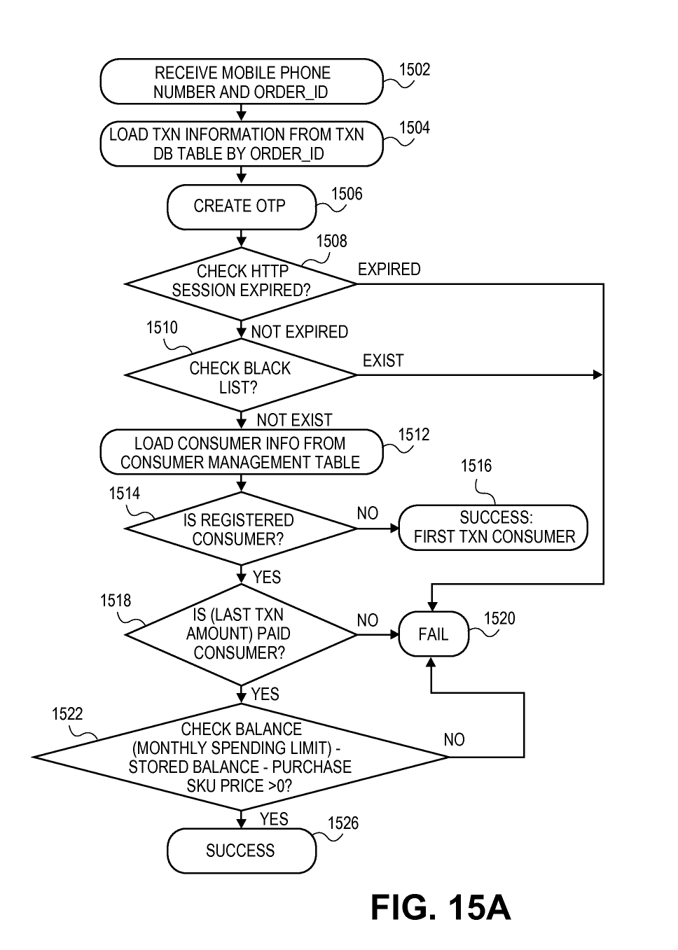

FIG. 14 illustrates an exemplary user interface for an encrypt request message creator on a merchant portal site in accordance with one embodiment. The user interface 1400 includes an input field 1410 for entering a stock-keeping unit (SKU) name, an input field 1420 for entering a SKU ID, and an input field 1430 for entering a SKU price. A consumer can enter the SKU information in the input area 1432 and select the submit option 1440. In response, an encrypted HTTP request message is generated and displayed in region 1450. This encrypted message can be copied and pasted into a SKU payment page.

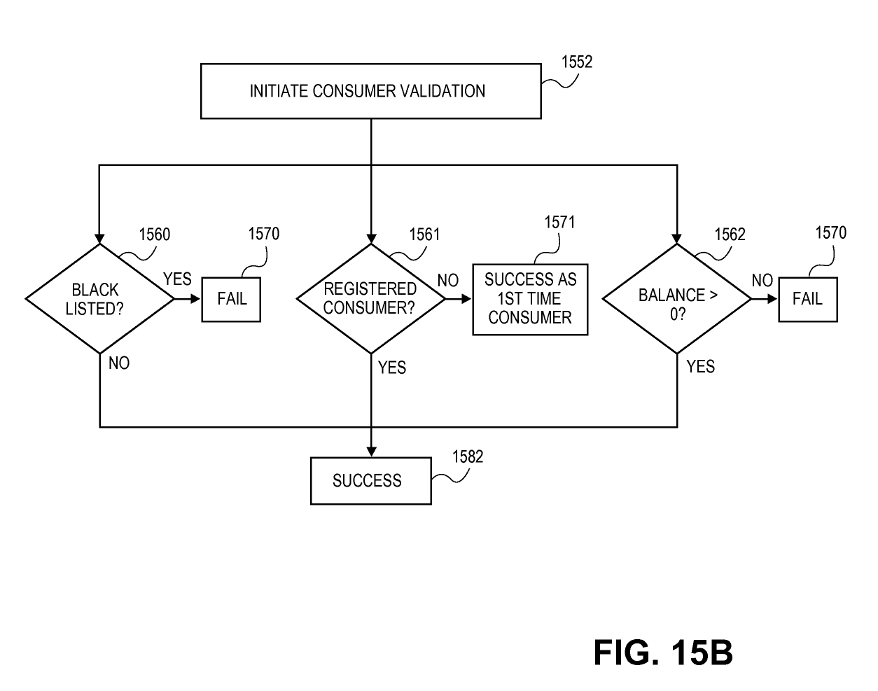

FIG. 15A illustrates a flow diagram of one embodiment for a method 1500 of validating a consumer with a payment system. The method 1500 is performed by processing logic that may comprise hardware (circuitry, dedicated logic, etc.), software (such as is run on a general purpose computer system or a dedicated machine or a device), or a combination of both. In one embodiment, the method 1500 is performed by processing logic of the payment processor or payment system discussed herein.

At block 1502, the processing logic receives a mobile phone number and order_id from a consumer in a similar manner as discussed at block 402 of FIG. 4A. At block 1504, the processing logic of the payment system loads transaction information from a transaction database of the payment system based on the received order_id. At block 1506, the processing logic generates a one time password (OTP). At block 1508, the processing logic determines whether a session has expired for receiving the mobile phone number from the consumer. In one embodiment, the session expires based on a certain time period (e.g., 5 minutes from initiation of the transaction). At block 1520, the transaction fails based on expiration of the session.

At block 1510, the processing logic checks a black list for a match with information (e.g., mobile phone number, IP address, email address, consumer_ID, etc.) associated with the consumer. The transaction fails at block 1520 if a match exists with any black list. Otherwise, the processing logic loads consumer information from a consumer management table at block 1512. At block 1514, the processing logic determines whether the consumer is registered with the payment system. If the consumer is not registered, then the processing logic determines that consumer is transacting for the first time with the payment system and the consumer validation is a success at block 1516.

If the consumer is registered, then the processing logic determines whether the consumer has paid the most recent transaction amount at block 1518. If the consumer has not paid, then the transaction fails at block 1520. If the consumer has paid, then the processing logic checks an account balance of the consumer with the payment system. In an embodiment, the processing logic determines whether a monthly spending limit minus a stored balance minus a purchase SKU price is greater than zero. If so, then the processing logic may optionally determine whether the consumer has authenticated at the payment system's site using a third party authentication method. The consumer validation is a success at block 1526. The consumer validation fails at block 1520 if the account balance is less than zero.

FIG. 15B illustrates a flow diagram of another embodiment for a method 1550 of validating a consumer with a payment system having a parallel processing mechanism. The method 1550 is performed by processing logic that may comprise hardware (circuitry, dedicated logic, etc.), software (such as is run on a general purpose computer system or a dedicated machine or a device), or a combination of both. In one embodiment, the method 1550 is performed by processing logic of the payment processor or payment system discussed herein.

The payment system may use a parallel (distributed) processing mechanism to save transaction time. For example, consumer validation may be considered a task that has three sub tasks including checking a black list, checking an account balance, and determining whether a consumer is transacting with the payment system for the first time.

At block 1552, the processing logic initiates consumer validation in a similar manner as discussed at blocks 1502, 1504, 1506, 1508, and 1512 of FIG. 15A. At blocks 1560-1562, the processing logic uses a parallel processing mechanism to concurrently check three different sub tasks. In an embodiment, a first sub task is checking a black list for a match with information (e.g., mobile phone number, IP address, email address, consumer_ID, etc.) associated with the consumer (block 1560), a second sub task is determining whether the consumer is registered with the payment system (block 1561), and a third sub task is checking an account balance of the consumer with the payment system (block 1562).

The transaction fails at block 1570 if a match exists with any black list. If the consumer is not registered with the payment system at block 1561, then the processing logic determines that the consumer is transacting for the first time with the payment system and the consumer validation is a success at block 1571. The consumer validation fails at block 1570 if the account balance is not greater than zero.

The process proceeds to block 1582 if the consumer is not black listed at block 1560, the consumer is registered with the payment system at block 1561, and the balance is greater than zero at block 1562. The consumer validation is now a success at block 1582.

Optionally, if the consumer is registered at block 1561, then the processing logic determines whether the consumer has paid the most recent transaction amount. If the consumer has not paid, then the transaction fails. If the consumer has paid, then the process proceeds to block 1582. Alternatively, the determination of whether the consumer has paid the most recent transaction amount can be a separate path performed in parallel with blocks 1560-1562.

In another embodiment, completing a transaction is a task with numerous sub tasks that can be completed in parallel. For example, to complete the payment transaction, a payment transaction server of the payment system sends a notification of transaction success or failure to the consumer and merchant. The transaction may be applied with a promotion property. In this case, six sub tasks may be performed in parallel by the payment transaction server as follows. The payment transaction server can apply a promotional price to a core transaction server, send a request to deduct from a consumer's payment account to a customer account module, send a transaction success SMS message to the consumer, send a transaction success email message to the consumer, update transaction information to a transaction database, and register a subscription transaction to a recurring process scheduler if the transaction includes a subscription SKU. These sub tasks are performed in parallel by the payment transaction server to save transaction processing time.

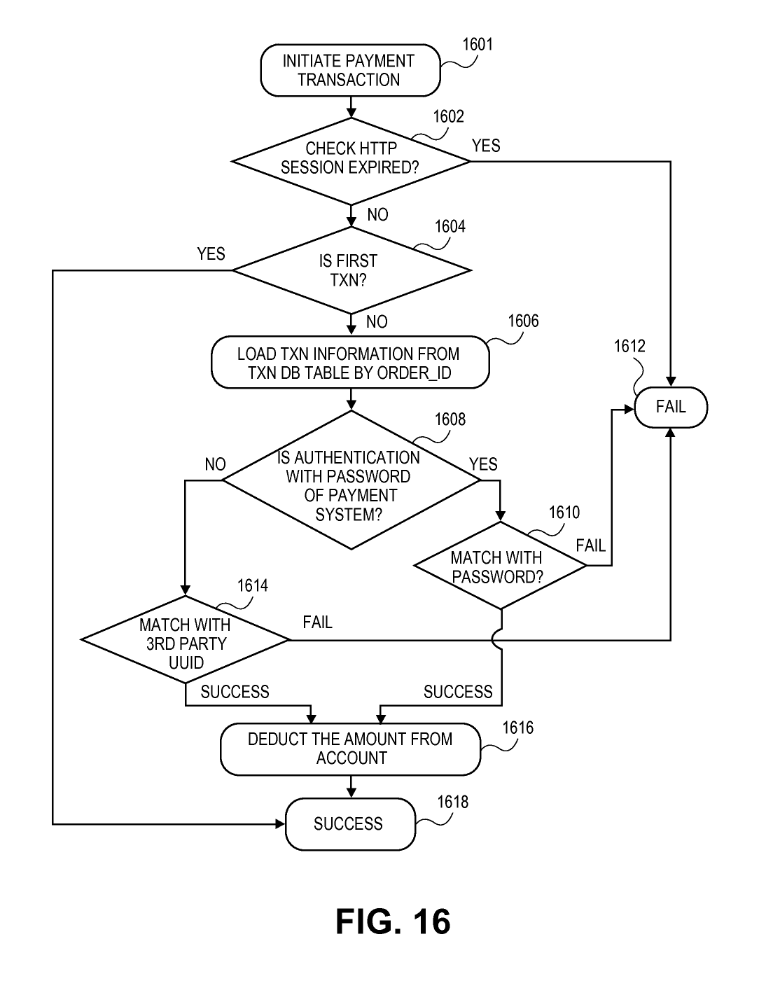

As discussed above, the payment system supports three types of authentication methods. FIG. 16 illustrates a flow diagram of one embodiment for a method 1600 of authenticating a consumer with a payment system. The method 1600 is performed by processing logic that may comprise hardware (circuitry, dedicated logic, etc.), software (such as is run on a general purpose computer system or a dedicated machine or a device), or a combination of both. In one embodiment, the method 1600 is performed by processing logic of the payment processor or payment system discussed herein.

At block 1601, the processing logic initiates a payment transaction in response to receiving a payment transaction request. At block 1602, the processing logic determines whether a session has expired for completing the transaction. In one embodiment, the session expires based on a certain time period (e.g., 5 minutes from initiation of the transaction). At block 1612, the transaction fails based on expiration of the session. At block 1604, if the session has not expired, then the processing logic determines whether the consumer is performing a first transaction with the payment system. At block 1606, for a subsequent transaction, the processing logic of the payment system loads transaction information from a transaction database of the payment system based on an order_id received from the consumer. At block 1608, the processing logic determines whether the consumer is authenticating with a password associated with the payment system. At block 1610, for authentication with the consumer's password with the payment system, the processing logic checks the password received from the consumer for a match with a password associated with the payment system. If no match is found, then the transaction fails at block 1612. If a match is found, then the transaction proceeds to deduct a transaction amount from the consumer's account at block 1616. The authentication completes successfully at block 1618.

Returning to block 1604, if a first transaction occurs, then the authentication is successful at block 1618. Returning to block 1608, if the consumer is not authenticating with a password associated with the payment system, then the processing logic attempts to match the received password from the consumer with a universally unique identifier (UUID) (e.g., 64 bit numeric type) associated with a third party. If no match is found, then the authentication fails at block 1612. If a match is found, then the transaction proceeds to deduct a transaction amount from the consumer's account at block 1616. The authentication completes successfully at block 1618.

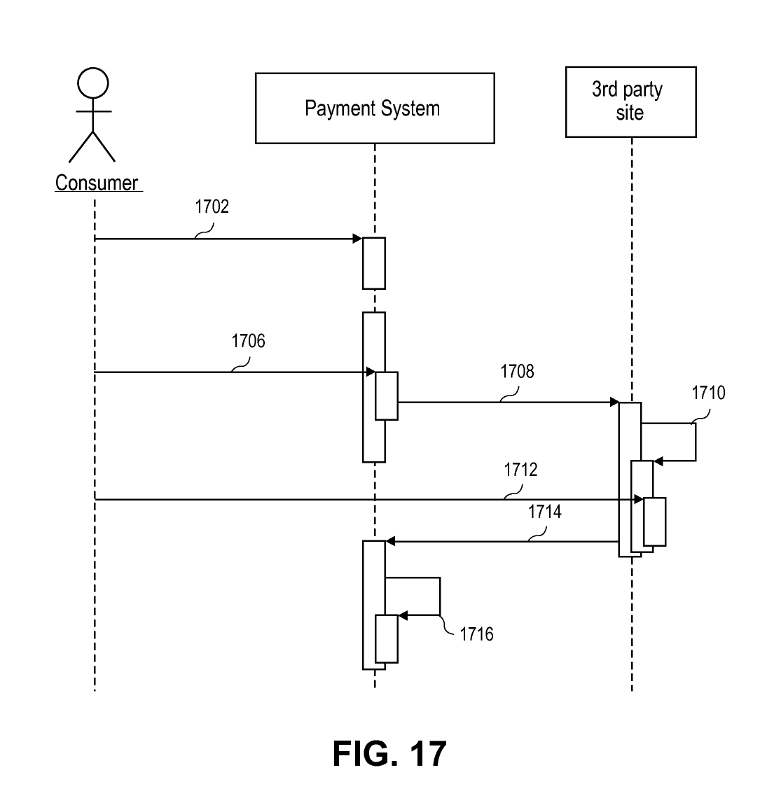

A third party authentication may occur during a consumer's registration with the payment system or during a consumer's transaction with a merchant. FIG. 17 illustrates one embodiment of a consumer's authentication during registration with the payment system. The method 1700 is performed by processing logic that may comprise hardware (circuitry, dedicated logic, etc.), software (such as is run on a general purpose computer system or a dedicated machine or a device), or a combination of both. In one embodiment, the method 1700 is performed by processing logic of the payment processor or payment system discussed herein.

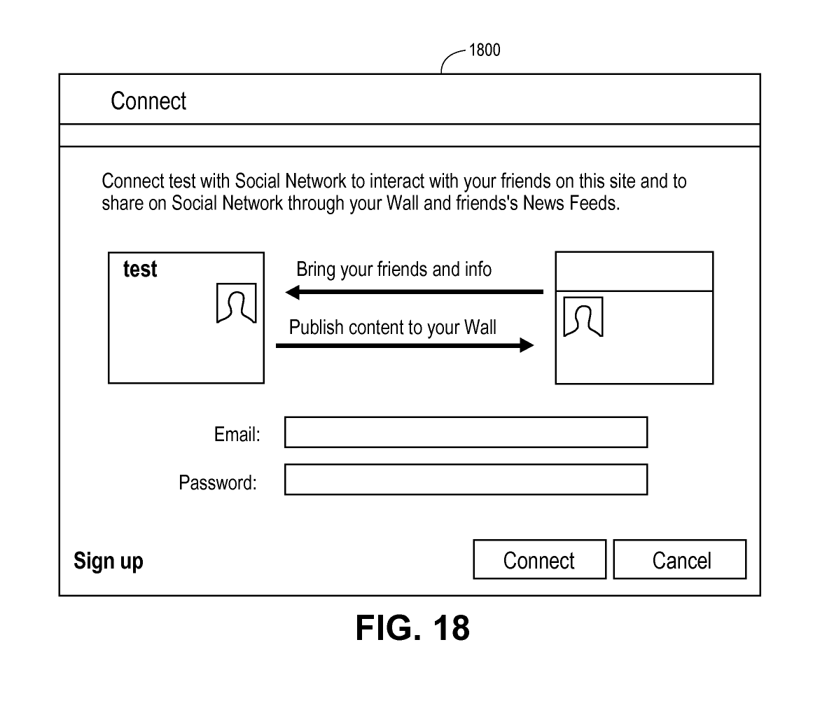

At operation 1702, an online portal of the payment system receives user information from an electronic device of the consumer. At operation 1706, the processing logic of the payment system receives a selection of a third party site from the consumer. At operation 1708, the processing logic sends a request for a login window to the third party site. At operation 1710, the third party site generates and displays to the electronic device a login window. FIG. 18 illustrates an exemplary login window 1800 of a third party (e.g., Facebook, Twitter, OpenID, etc) in accordance with one embodiment. At operation 1712, the third party site receives login information from the consumer. At operation 1714, the processing logic receives a consumer's universally unique identifier (UUID) from the third party site. At operation 1716, the processing logic saves the UUID to a consumer database (e.g., consumer table). Thus, the consumer is able to register with the payment system by authenticating with the third party (e.g., social media merchant, OpenID).

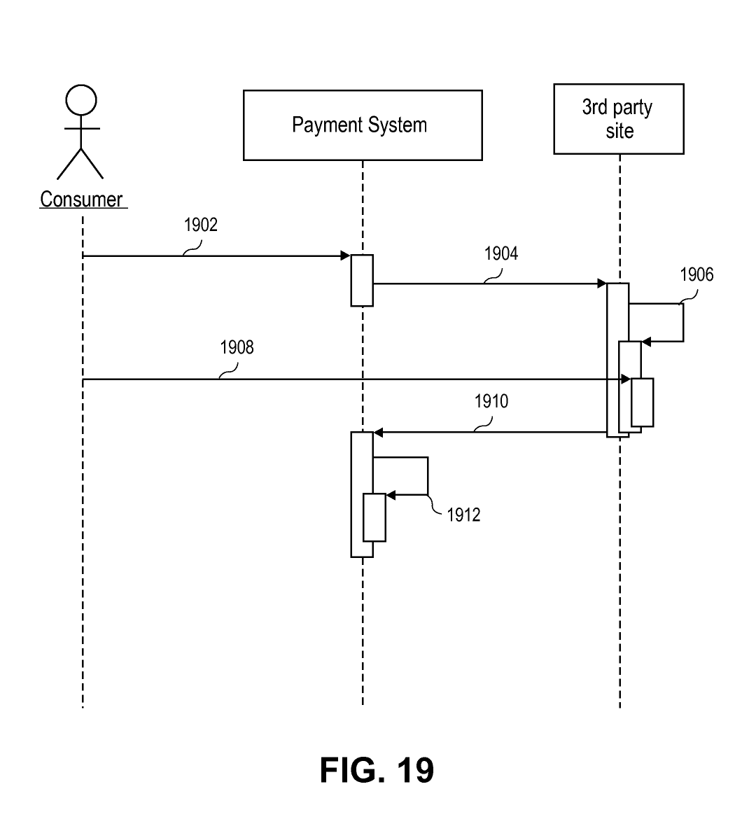

FIG. 19 illustrates one embodiment of a consumer's authentication during a payment transaction with the payment system. The method 1900 is performed by processing logic that may comprise hardware (circuitry, dedicated logic, etc.), software (such as is run on a general purpose computer system or a dedicated machine or a device), or a combination of both. In one embodiment, the method 1900 is performed by processing logic of the payment processor or payment system discussed herein.

At operation 1902, an online portal of the payment system receives user information and a selection of a third party login option from an electronic device of the consumer. At operation 1904, the processing logic sends a request for a login window to a third party site. At operation 1906, the third party site generates and displays to the electronic device a login window. At operation 1908, the third party site receives login information from the consumer. At operation 1910, the processing logic receives a consumer's UUID from the third party site. At operation 1912, if the processing logic matches the received UUID with a previously stored UUID, then the authentication is successful.

In an embodiment, the operations of method 1900 occur when the consumer has attempted a third party login during a transaction. The consumer needs to have previously authenticated during registration or account management.

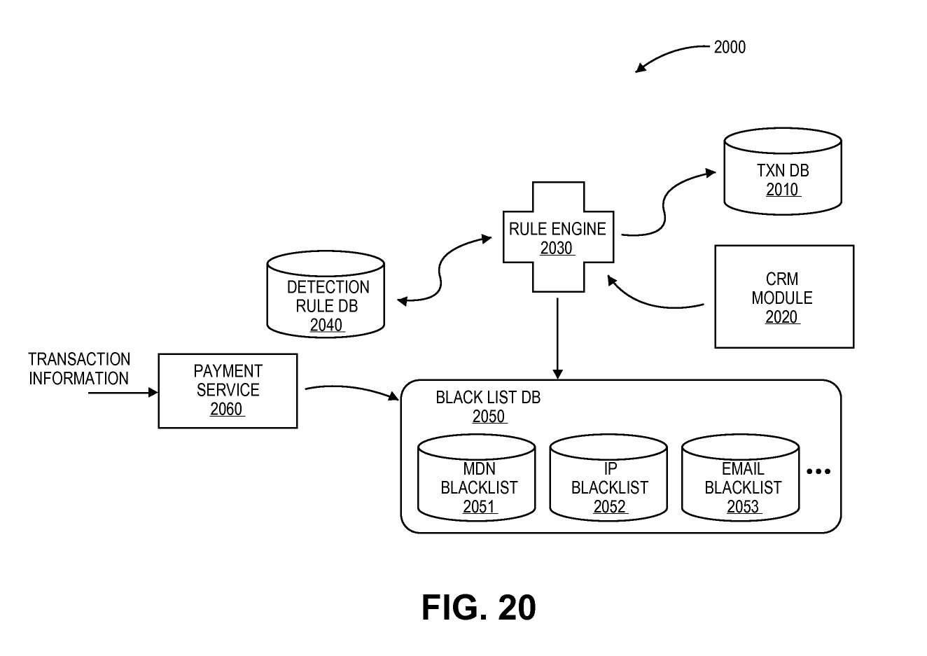

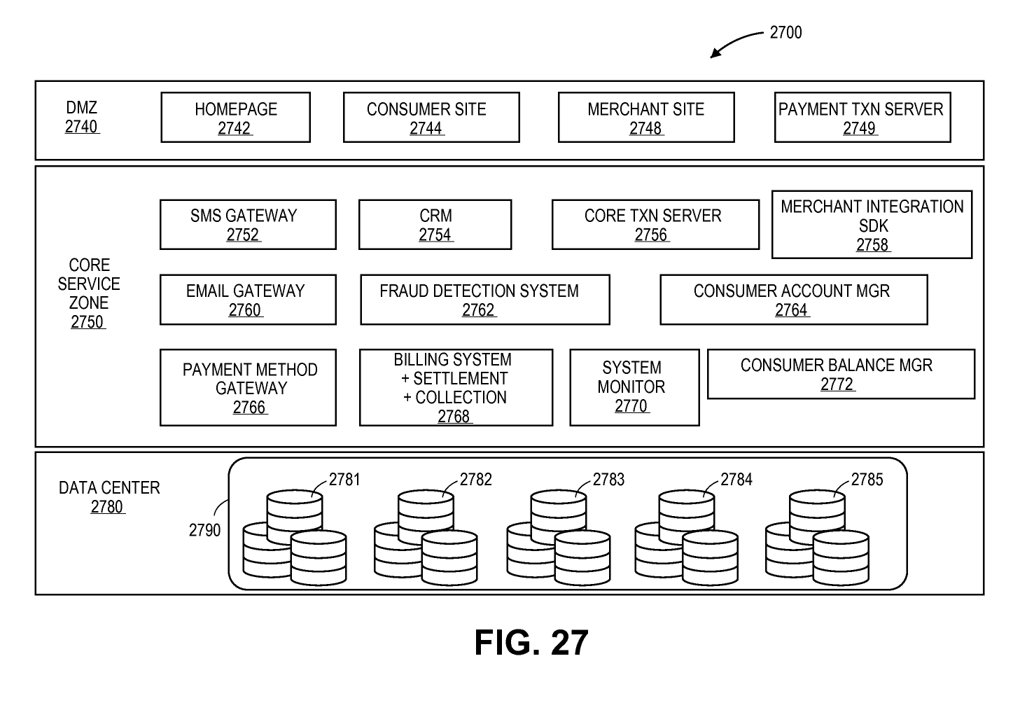

FIG. 20 illustrates a block diagram of a fraud detection system in accordance with certain embodiments. The fraud detection system 2000 includes or accesses a rule engine 2030, a consumer relationship management (CRM) module 2020, a detection rule database 2040, a transaction database 2010, and a black list database 2050. In an embodiment, the CRM module 2020 enables the creation of a fraud detection rule. The rule engine 2030 loads each rule and processes each rule repeatedly. The detection rule database 2040 stores fraud detection rules, the transaction database 2010 stores fraud transaction patterns, and the black list database 2050 stores different types of black lists (e.g., mobile phone number, IP address, email, etc.). The system 2000 communicates with a payment service 2060 that provides transaction information to the black list database 2050. The fraud detection system (e.g., 2000, 2762, 2862, 2962) may be part of a payment system (e.g., 130, 230, 2700, 2810, 2910). The rule engine 2030 and CRM module 2020 may be part of a core service zone (e.g., 2710, 2810, 2910) and the databases 2010, 2040, 2050 may be part of a data center (e.g., 2780, 2880, 2980) discussed below in conjunction with FIGS. 27-29.

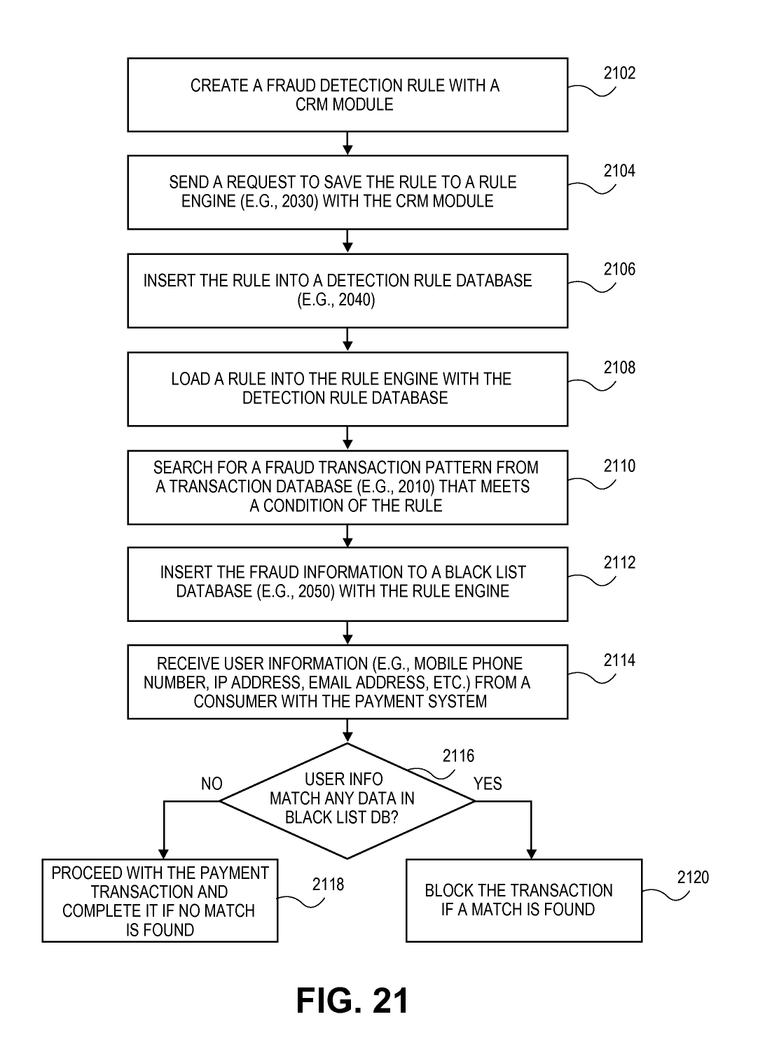

FIG. 21 illustrates a method of operating a fraud detection system of a payment system in accordance with certain embodiments. The method 2100 is performed by processing logic that may comprise hardware (circuitry, dedicated logic, etc.), software (such as is run on a general purpose computer system or a dedicated machine or a device), or a combination of both. In one embodiment, the method 2100 is performed by processing logic of the fraud detection system 2000.

At block 2102, a risk manager uses a CRM module (e.g., 2020) to create a fraud detection rule. For example, the risk manager creates the rule using a composition of consumer information (e.g., email address, mobile phone number (e.g., mobile directory number (MDN)), login ID on merchant site, IP address, etc.) In certain embodiments, examples of fraud detection rules are listed below as follows.
1) IF more than 5 purchase transaction requests are received from the same IP address within 15 minutes, THEN save the IP address to IP address blacklist database for 7 days;
2) IF the same customer and associated MDN attempts to pay for transaction more than 5 times within 2 minutes, THEN save the MDN, IP address and email address of the customer to the respective blacklist database for 24 hours;
3) IF the same customer and associated MDN attempts to pay for transaction with different login identifiers more than 3 times within 24 hours, THEN save the MDN to MDN blacklist database for 30 days;
4) IF same customer and associated MDN always fails to pay for transaction within 30 days of purchase, THEN save the MDN and email address to MDN and email blacklist database forever;
5) IF the total price of successful transactions is more than 1000 dollars for 30 minutes in same C class IP address, THEN save the C class IP address to C-Class IP blacklist database forever; and
6) IF the same customer and associated MDN attempts to pay for transaction from different IP address more than 10 times per 1 hour, THEN save the MDN and C class IP to the respective blacklist database for 30 days.

At block 2104, the risk manager uses the CRM module to send a request to save the rule to a rule engine (e.g., 2030). Next, the rule is inserting into a fraud detection rule database (e.g., 2040) at block 2106. The risk manager 2010 can create, delete, and update detection rules.

At block 2108, the risk manager can load a rule from the fraud detection rule database into the rule engine. At block 2110, the rule engine searches for a fraud transaction pattern from a transaction database (e.g., 2010) that meets a condition of a fraud detection rule. Examples of fraud transaction patterns include a certain number of transactions in a certain time period for a particular consumer (e.g., 5 transactions/minute), velocity based fraud (e.g., same mobile phone number provided that is associated with four different IP addresses), geolocation based fraud, merchant based patterns, etc. At block 2112, the rule engine then inserts the fraud information (e.g., mobile phone number, IP address, email address, etc.) into a black list database (e.g., 2050). The database may include a mobile phone number black list database 2051, an IP address black list database 2052, an email address block list database 2053, and also any other type of black list database. Other types of databases include a login ID for a merchant site database, a ranged IP address blacklist (e.g., C-class IP (XXX.XXX.XXX.0˜XXX.XXX.XXX.255). The rule engine processes one or more rules repeatedly in view of fraud transaction patterns.

At block 2114, in one embodiment, a payment service (e.g., 2060) of the payment system receives user information (e.g., mobile phone number, IP address, email address, etc.) from a consumer. Next, at block 2116, the payment service of the payment system determines if the user information matches any of the data in the black list database 2050. For example, if a consumer submits a mobile phone number, then the payment service of the payment system searches the black list 2051 for a match. At block 2118, the payment service of the payment system proceeds with the payment transaction and completes it if no match is found at block 2116. At block 2120, the transaction is blocked by the payment service of the payment system if a match is found at block 2116.

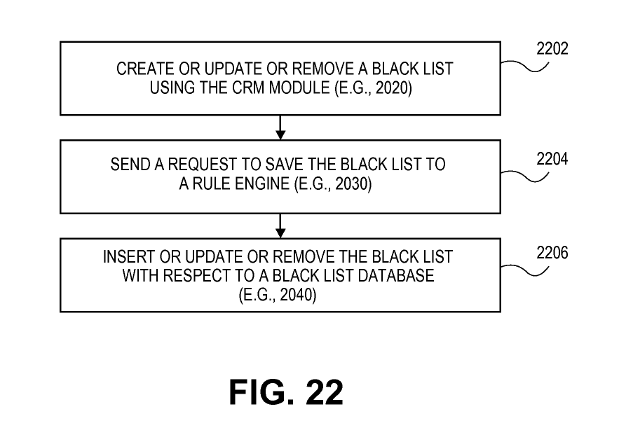

FIG. 22 illustrates a method of operating a fraud detection system in accordance with another embodiment. The method 2200 is performed by processing logic that may comprise hardware (circuitry, dedicated logic, etc.), software (such as is run on a general purpose computer system or a dedicated machine or a device), or a combination of both. In one embodiment, the method 2200 is performed by processing logic of the fraud detection system 2000.

At block 2202, a risk manager creates or updates or removes a black list using the CRM module (e.g., 2020). At block 2204, the CRM module sends a request to save the black list to a rule engine (e.g., 2030). Next, the black list is inserted or updated or removed with respect to a black list database (e.g., 2040) at block 2206. The risk manager can create, delete, and update black list databases.

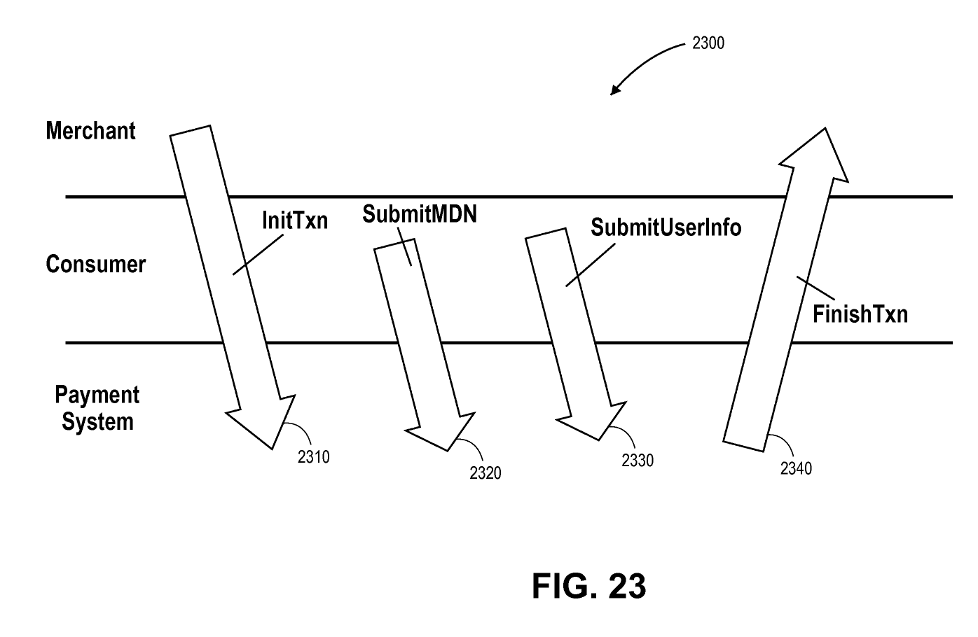

FIG. 23 illustrates an overview of protocols for a mobile payment transaction according to one embodiment. The payment transaction 2300 includes an initiate transaction protocol 2310, a submit mobile phone number protocol 2320, a submit user information protocol 2330, and a finish transaction protocol 2340. The initiate transaction protocol 2310 is used with the payment transaction request (e.g., 252) that is sent from a merchant to the payment system. The submit mobile phone number protocol 2320 is used with the submit mobile phone number request (e.g., 256) and the submit mobile phone number response (e.g., 258) that are sent between a consumer and the payment system. The submit user information protocol 2330 is used with the submit user information request (e.g., 262) and the submit user information response (e.g., 265) that are sent between a consumer and the payment system. The finish transaction protocol 2340 is used with the finish transaction message (e.g., 267) that is sent from the payment system to the merchant.

Various databases have been described throughout the present application. A transaction table stored in a transaction database in accordance with one embodiment may include a transaction ID, an order ID, a merchant ID, a service ID, a service name, a request ID, a MDN, a transaction type, a transaction status, a status code, a first time transaction indicator, a consumer IP address, etc. In another embodiment, a transaction table includes transaction session SKU information such as transaction ID, SKU ID, price, etc.

An exemplary table found in a merchant database (e.g., 308) in accordance with one embodiment includes a service ID, a service name, a merchant ID, a merchant name, a secretkey, etc.

An exemplary table found in a consumer database (e.g., 418, 1118, 2116) in accordance with one embodiment may include an ID, an email address, a password, a third party user ID, a MDN, a status, etc.

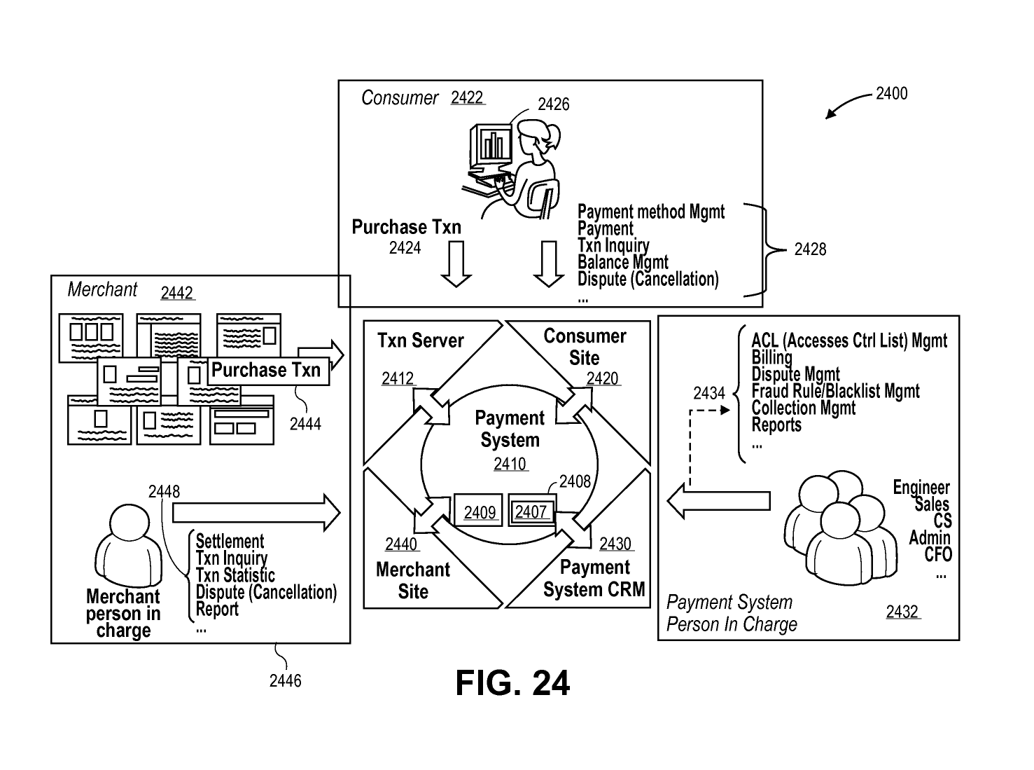

FIG. 24 illustrates a system overview for a payment transaction with a payment system in accordance with certain embodiments. The system 2400 allows a consumer 2422 (e.g., customer), a merchant 2442, and a payment system 2410 to interact to process a payment transaction. A consumer 2422 using an electronic device 2426 generates a purchase transaction 2424. The consumer manages payment features 2428 (e.g., payment method management, payment, transaction inquiry, balance management, and dispute (cancellation)) using the electronic device 2426 that accesses a consumer site 2420. A payment system 2410 includes processing system 2409 and data storage device 2408. The processing system 2409 implements core management and control systems. The data storage device 2408 may include a machine-accessible storage medium 2407 on which is stored one or more sets of instructions (e.g., software) embodying any one or more of the methodologies or functions described herein. The software may also reside, completely or at least partially, within the processing system 2409 during execution thereof by the processing system 2409, the processing system 2409 also constituting machine-accessible storage media.

The machine-accessible storage medium 2407 may also be used to store data structure sets (e.g., databases) that store consumer, merchant, transaction, and payment system information as discussed herein. While the machine-accessible storage medium 2407 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the present invention. The term “machine-accessible storage medium” shall accordingly be taken to include, but not be limited to, solid-state memories, optical, and magnetic media.

The payment system 2410 communicates with a transaction server 2412, a consumer site 2420, a CRM module 2430, and a merchant site. A merchant 2442 provides goods or services and generates a purchase transaction 2444. A merchant person in charges 2446 manages features 2448 (e.g., settlement, transaction inquiry, transaction statistic, dispute (cancellation), reports, etc.) and communicates with the merchant site 2440. A payment system person in charge 2432 manages payment system features and systems 2434 (e.g., access control list management, billing, dispute management, fraud rule/blacklist management, collection management, reports, etc) and communicates with the CRM site 2430.

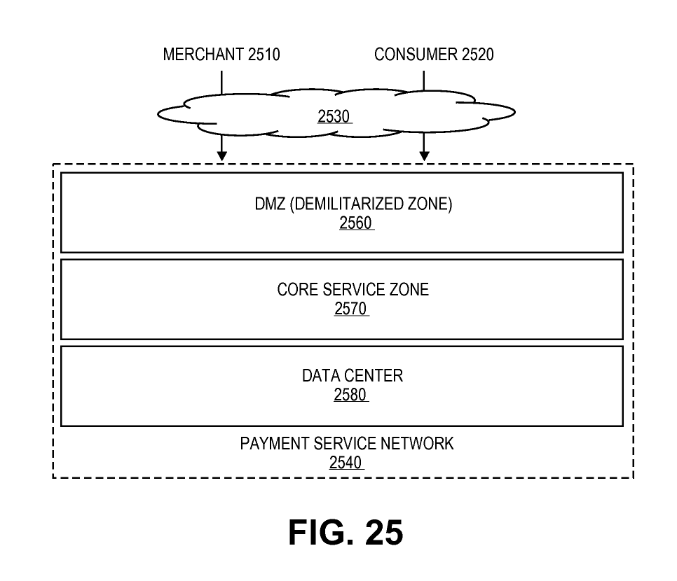

FIG. 25 illustrates a network topology for a payment transaction with a payment system in accordance with certain embodiments. A network topology 2500 includes a merchant 2510, a consumer 2520, a communication network 2530 (e.g., Internet), and a payment service network 2540 associated with the payment system. The network 2540 includes a demilitarized zone (DMZ) 2560 (e.g., public network to expose external service), a core service zone 2570 (e.g., private network for internal core service—campus network), and a data center 2580, which is a strongly secured network for databases.

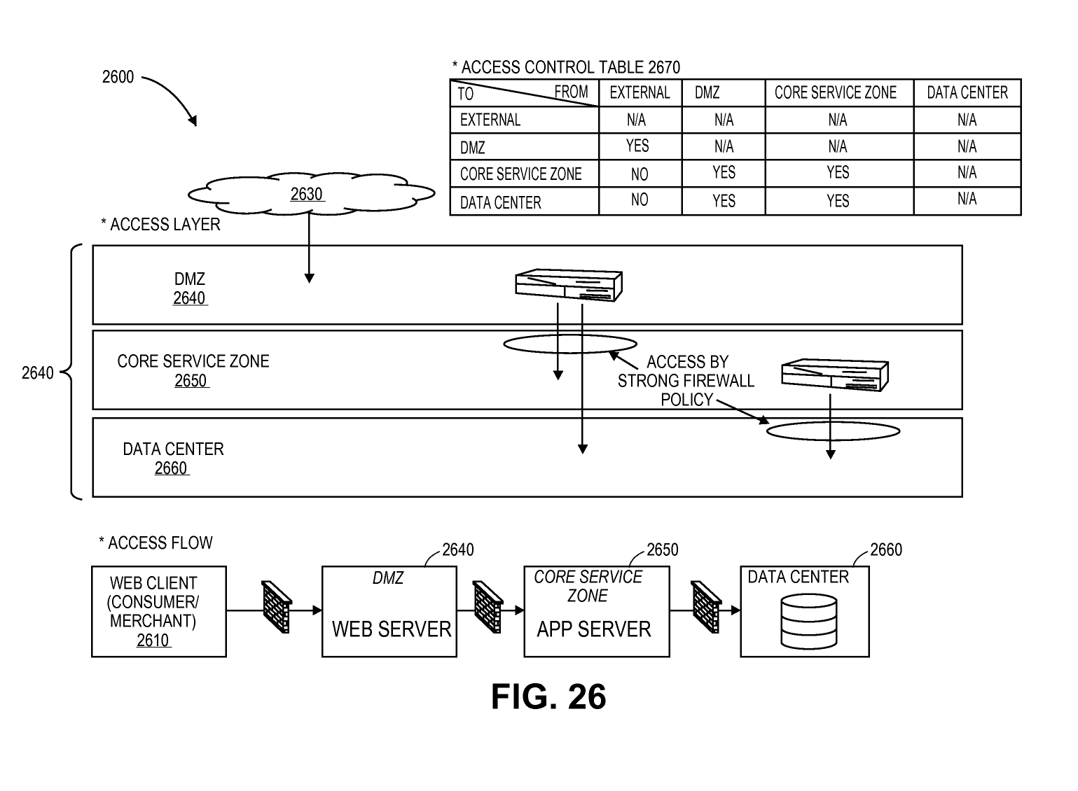

FIG. 26 illustrates a network topology for a payment transaction with a payment system in accordance with another embodiment. A network topology 2600 for a payment system includes a web client 2610 (e.g., consumer/merchant), a communication network 2630 (e.g., Internet), and a payment service network 2640. The network 2640 includes a demilitarized zone 2660 implemented with web server(s), a core service zone 2670 implemented with application server(s), and a data center 2680 implemented with databases. An access control table 2670 shows the accessibility between different layers.

FIG. 27 illustrates a payment system for a payment transaction in accordance with one embodiment. The payment system 2700 is associated with a DMZ 2740, a core service zone 2750, and a data center 2780. The payment system 2700 may be implemented as part of a collocation center model where multiple consumers and merchants locate network, server and storage gear and interconnect to a variety of telecommunications and other network service provider(s) with a minimum of cost and complexity. For example, the payment system 2700 includes or communicates with a payment system site (e.g., home page) 2742, a consumer site 2744, a merchant site 2748, and a payment transaction server 2749. In an embodiment, the payment system 2700 does not include the merchant site 2848 and the consumer site 2844. The payment system 2700 includes or communicates with a SMS gateway 2752, a CRM module 2754, a core transaction server 2756, a merchant integration software design kit 2758, an email gateway 2760, a fraud detection system 2762, a consumer account manager 2764, a payment method gateway 2766, a billing system 2768, a system monitor 2770, and a consumer balance manager 2772. The data center 2780 includes databases 2781-2785.

In an embodiment, the components (e.g., payment transaction server 2749, CRM 2754, fraud detection system 2762, databases 2781-2785, etc.) may include or may be stored on a machine-accessible storage medium. For example, the fraud detection system may include a single medium or multiple media (e.g., a centralized or distributed database, and/or associated caches and servers) that store the one or more sets of instructions associated with the fraud detection system. The data center 2780 may include a machine-accessible storage medium 2790 that is used to store data structure sets (e.g., databases 2781-2785) that store consumer, merchant, transaction, and payment system information as discussed herein.

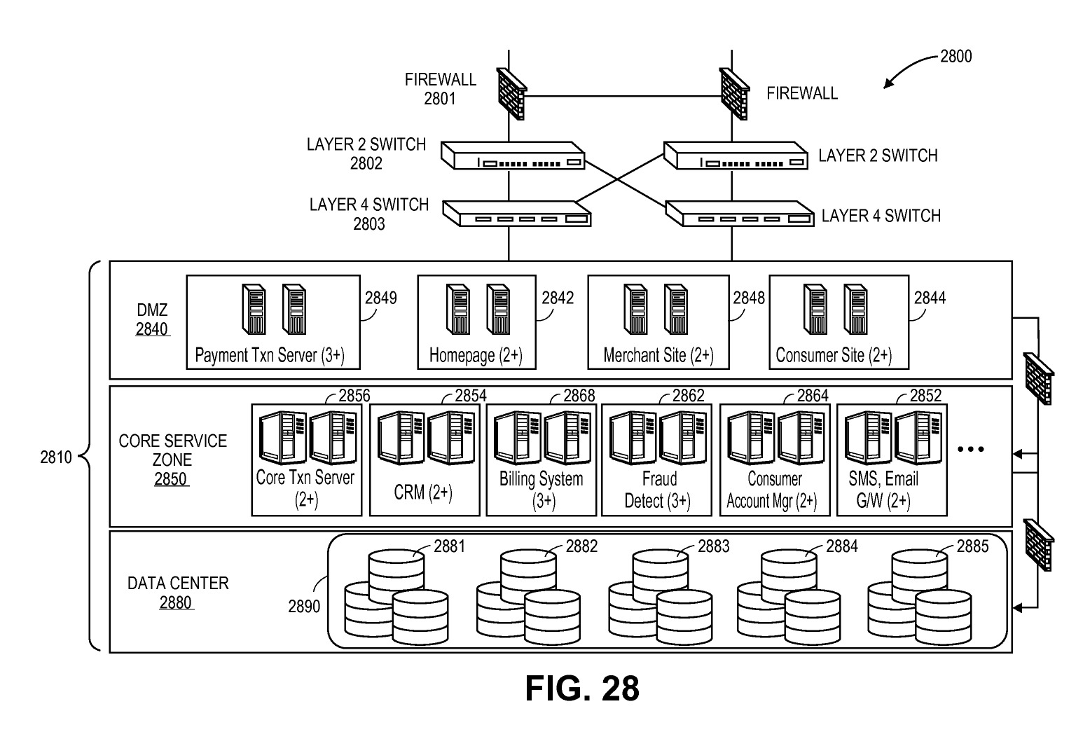

FIG. 28 illustrates a network topology for a payment transaction with a payment system in accordance with another embodiment. The network topology 2800 includes firewalls 2801, layer 2 switches 2802, layer 4 switches 2803, a DMZ 2840, a core service zone 2850, and a data center 2880. The payment system 2810 may be implemented as part of a collocation center model. For example, the payment system 2810 includes or communicates with a payment system site (e.g., website home page) 2842, a consumer site 2844, a merchant site 2848, and a payment transaction server 2849. In an embodiment, the payment system 2810 does not include the merchant site 2848 and the consumer site 2844. The payment system 280 includes or communicates with a SMS/email gateways 2852, a CRM module 2854, core transaction servers 2856, a fraud detection system 2762, a billing system 2768, etc. The data center 2880 includes databases 2881-2885.

In an embodiment, the components (e.g., payment transaction server 2849, CRM 2854, fraud detection system 2862, databases 2881-2885, etc.) may include or may be stored on a machine-accessible storage medium. For example, the fraud detection system may include a single medium or multiple media (e.g., a centralized or distributed database, and/or associated caches and servers) that store the one or more sets of instructions associated with the fraud detection system. The data center 2880 may include a machine-accessible storage medium 2890 that is used to store data structure sets (e.g., databases 2781-2785) that store consumer, merchant, transaction, and payment system information as discussed herein.

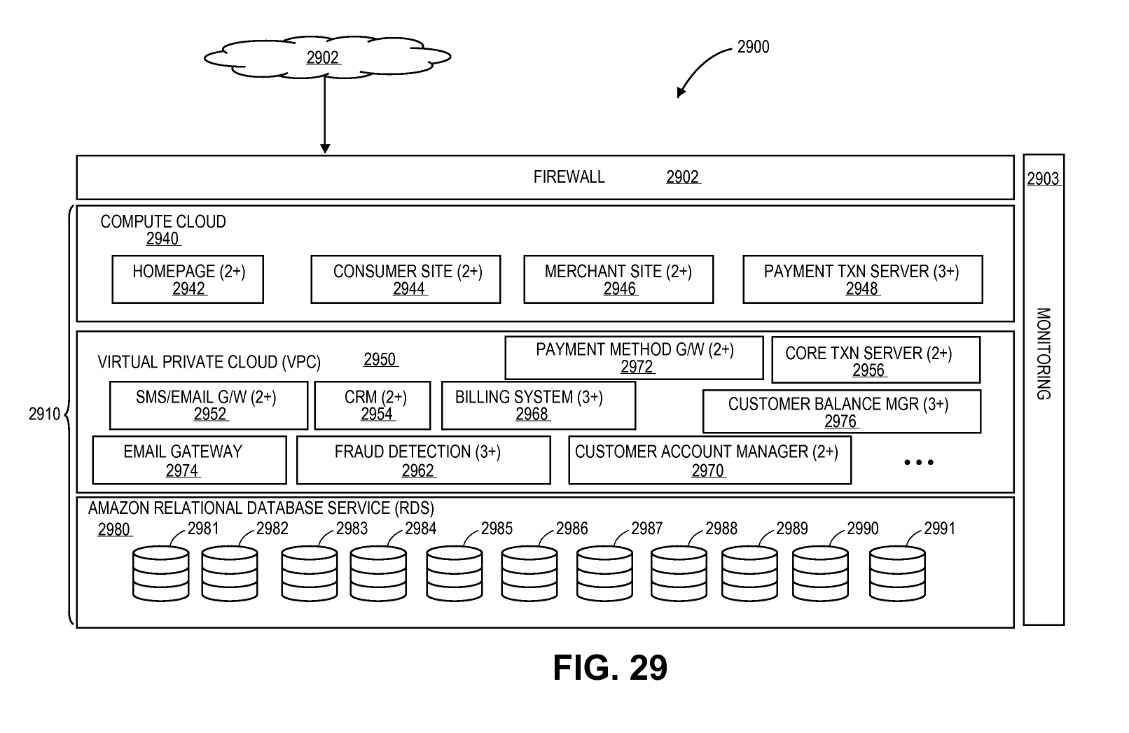

FIG. 29 illustrates a network topology for a payment transaction with a cloud service model and payment system in accordance with another embodiment. The cloud service model is Internet-based computing in which shared resources, software, and information are provided to computers and other devices on-demand. The cloud service model can be provided by various services providers (e.g., Amazon, Google, Microsoft). In an embodiment, Amazon Elastic Compute Cloud (Amazon EC2) Environment is the cloud service model.

The network topology 2900 couples to a communication network (e.g., Internet) 2902 and includes a firewall (e.g., EC2 load balancing and security layer) 2902, a monitoring module (e.g., Amazon EC2 cloudwatch) 2903, and a payment system 2910. The payment system 2910 includes a compute cloud 2940 (e.g., Amazon EC2), a virtual private cloud (VPC) 2950, and a relational database service 2980 that includes databases 2881-2991.

The compute cloud 2940 includes or communicates with a payment system site (e.g., website home page) 2942, a consumer site 2944, a merchant site 2948, and payment transaction servers 2949. In an embodiment, the payment system 2910 does not include the merchant site 2848 and the consumer site 2844. The VPC (e.g., Amazon VPC) 2950 includes or communicates with a SMS/email gateways 2952, a CRM module 2954, core transaction servers 2956, a fraud detection system 2962, a billing system 2968, a consumer account manager 2970, payment method gateways 2972, an email gateway 2974, a consumer balance manager 2976, etc.

In an embodiment, the components (e.g., payment transaction server 2948, CRM 2954, fraud detection system 2962, databases 2981-2991, etc.) may include or may be stored on a machine-accessible storage medium. For example, the fraud detection system 2962 may include a single medium or multiple media (e.g., a centralized or distributed database, and/or associated caches and servers) that store the one or more sets of instructions associated with the fraud detection system. The data center 2980 may include a machine-accessible storage medium that is used to store data structure sets (e.g., databases 2781-2785) that store consumer, merchant, transaction, and payment system information as discussed herein.

In certain embodiments, a payment system (e.g., 2710, 2810, 2910) process a payment transaction with no mobile carrier dependency. The payment system includes at least one web server (e.g., payment transaction server) to receive a payment transaction request, at least one application server (e.g., core transaction server) to provide payment services between a consumer and a merchant based on a mobile phone number of the consumer, and a data center to store transaction information, consumer information, and merchant information associated with the payment transaction.

In one embodiment, a consumer with an electronic device (e.g., mobile device, computing device, computer, laptop, tablet, netbook, hand-held device, etc.) shops for a product (e.g., item, content) or service from an online merchant's site and selects a payment option to purchase the product or service. A payment transaction server 3010 (e.g., server 2749, server 2849, server 2949) receives a payment transaction request from an online merchant. The payment transaction server 3010 sends a verify merchant information request that includes merchant information to a core transaction server 3020 (e.g., server 2756, server 2856, server 2956). The core transaction server 3020 loads merchant information from a merchant database of the database systems 3030 and verifies the merchant information. The payment transaction server 3010 generates and saves transaction information in a transaction management database to complete initiation of a transaction.

Next, for consumer verification, the payment transaction server receives a mobile phone number from the consumer. The payment transaction server interacts with the fraud detection system, customer account module, and databases to verify customer information. The payment transaction server generates a OTP and sends it via a SMS gateway to the mobile device of the consumer. The payment transaction server then receives the OTP and additional authentication information from the consumer. The core transaction server performs customer authentication by loading transaction and customer information from databases and verifying the OTP and additional authentication information.

Then, to complete the payment transaction, the payment transaction server sends a notification of transaction success or failure to the consumer and merchant.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method for third party authentication with a payment system for a payment transaction based on a mobile phone number, the method comprising:
receiving, with the payment system, user information from an electronic device of the consumer;
receiving, with the payment system, a selection of a third party authentication option from the consumer;
sending, with the payment system, a request for a login window to a third party site; and
receiving, with the payment system, a consumer's universally unique identifier (UUID) from the third party site in response to a consumer's login to the third party site.

2. The method of claim 1, further comprising:
receiving, with the payment system, a selection of the third party site from the consumer.

3. The method of claim 1, further comprising:
saving, with the payment system, the UUID to a customer database.

4. The method of claim 1, wherein the consumer logs into the third party site using the login window.

5. The method of claim 1, wherein receiving, with the payment system, a consumer's universally unique identifier (UUID) from the third party site in response to a consumer's login to the third party site in order to register the consumer with the payment system by authenticating with the third party site.

6. The method of claim 1, further comprising:
matching, with the payment system, the received UUID with a previously stored UUID in order to successfully authenticate the consumer.

7. The method of claim 6, further comprising:
authenticating the consumer with the payment system during registration or account management.

8. The method of claim 6, wherein the consumer logs into the third party site using the login window.

9. A method of operating a fraud detection system of a payment system, the method, comprising:
receiving, with the payment system, user information from an electronic device of the consumer and a mobile phone number associated with a mobile device of the consumer;
loading, from a fraud detection rule database of the fraud detection system, a fraud detection rule into a rule engine of the fraud detection system;
searching, with the rule engine, for a fraud transaction pattern from a transaction database that meets a condition of the fraud detection rule; and
inserting, with the rule engine, fraud information associated with the fraud transaction pattern to a black list database.

10. The method of claim 9, further comprising:
determining, with the payment system, if the user information or mobile phone number matches any of the data in the black list database.

11. The method of claim 9, wherein the user information comprises an IP address or an email address of the consumer.

12. The method of claim 10, further comprising:
searching, with the payment system, the black list database for a match with the received user information or mobile phone number.

13. The method of claim 12, further comprising:
completing the payment transaction with the payment system if no match is found; and
blocking the payment transaction with the payment system if a match is found.

14. The method of claim 9, wherein the black list database comprises a mobile phone number black list database, an internet protocol (IP) address black list database, and an email address block list database.

15. The method of claim 9, wherein fraud transaction patterns comprise a certain number of transactions in a certain time period for a particular consumer, a common mobile phone number provided that is associated with a certain number of different IP addresses, and geolocation based fraud, and merchant based patterns.

16. The method of claim 15, wherein fraud transaction patterns comprise merchant based patterns.

17. A method of processing a consumer payment based on a mobile phone number of a mobile device of a consumer, the method comprising:
initiating a payment transaction with a payment system including receiving the mobile phone number from an electronic device of the consumer;
performing a task using a parallel processing mechanism of the payment system to concurrently perform a first sub-task, a second sub-task, and a third sub-task; and
completing the payment transaction.

18. The method of claim 17, wherein the task comprises a customer validation task and the first sub-task comprises checking a black list for a match with information associated with the consumer.

19. The method of claim 18, wherein the second sub-task comprises determining whether the consumer is registered with the payment system.

20. The method of claim 19, wherein the third sub-task comprises checking an account balance of the consumer with the payment system.
